(19) United States
(12) Patent Application Publication
(10) Pub. No.: US 2025/0198769 A1
(43) Pub. Date: Jun. 19, 2025

(54) Methods for Searching or Comparing Points Using Travel of Entities

(71) Applicant: Grzegorz Malewicz, Kielce (PL)

(72) Inventor: Grzegorz Malewicz, Kielce (PL)

(21) Appl. No.: 18/847,222

(22) PCT Filed: Mar. 31, 2023
(86) PCT No.: PCT/US2023/017010

§ 371 Date: Sep. 14, 2024

Related U.S. Application Data
(60) Provisional application No. 63/328,293, filed on Apr. 7, 2022.
(60) Provisional application No. 63/447,650, filed on Feb. 23, 2023.

(51) Int. Cl. G01C 21/34; G06Q 10/047

(52) U.S. Cl. CPC G01C 21/3423; G01C 21/3438; G01C 21/3446; G06Q 10/047

(57) ABSTRACT

The invention concerns searching or comparing points, based on travel of entities among some of the points within a transportation system. Embodiments include a real estate search engine, where a family can search or compare homes and schools, based on commute durations, considering that an adult wants to walk a child to a stop of a school bus. Embodiments also include approaches for solving an underlying optimization problem based on: an enumeration search, a tree search, a gradient descent search, and a branch-and-bound search. An embodiment scales a solution, by decomposing the optimization problem into independent subproblems, using a combinatorial optimization algorithm, that is applied to a certain travel graph. Scaling is also facilitated by a sparsification approach, that generalizes a routing method prevalent in prior art. Some of the approaches are part of a live real estate search engine available to users in South Korea and Japan.

### CROSS-REFERENCE TO RELATED APPLICATIONS

This application is based upon, and claims the priority dates of, applications:

| [Country] | [Application Number] | [Filing Date] |
|---|---|---|
| USA | 63/328,293 | Apr. 7, 2022, |
| USA | 63/447,650 | Feb. 23, 2023, |

which are incorporated herein by reference as if fully set forth.

### BACKGROUND OF THE INVENTION

The invention has a purpose of searching or comparing points, based on travel of entities among some of the points within a transportation system.

Similar purpose has been considered by prior art non-patent documents, including: Abraham, Delling, Fiat, Goldberg and Werneck: “HLDB: Location-based services in databases”, International Symposium on Advances in Geographic Information Systems, 2012; and Delling and Werneck: “Customizable Point-of-Interest Queries in Road Networks”, IEEE Transactions on Knowledge and Data Engineering, Vol. 3(27) 2015. The documents discuss relevant problems and approaches that include: the best via point problem, the ride sharing problem, the POI prediction problem, the k-closest POI problem, the k-best via problem, hub labels, single-hub indexing, double-hub indexing, multilevel overlays, customizable route planning, single-source indexing, and double-source indexing.

Similar purpose has also been considered by prior art patent documents, including: U.S. Pat. Nos. 4,870,576, 8,417,409, 9,195,953, 10,533,865, KR 101692501, JP 2006221565, and CN 104240163.

Similar purpose has also been considered by prior art interactive computer services developed in industry. A state of several such services was recorded on Apr. 7, 2022, as a recording number 1, and is depicted in FIG. 19 to FIG. 29 of a provisional patent application number U.S. 63/328,293, filed on the same day of Apr. 7, 2022. Specifically, the recording number 1 presents parts of the following websites concerning real estate search based on travel: zu.fang.com and house.focus.cn from China; athome.co.jp and homes.co.jp from Japan; realty.daum.net and new.land.naver.com from South Korea; foxtons.co.uk and zoopla.co.uk from the United Kingdom; and redfin.com and zillow.com from the United States. A state of several such services was subsequently recorded on Feb. 23, 2023, as a recording number 2, and is depicted in FIG. 19 to FIG. 55 of a provisional patent application number U.S. 63/447,650, filed on the same day of Feb. 23, 2023. Specifically, the recording number 2 presents parts of the following websites concerning real estate search based on travel: 515j.com, zu.fang.com and house.focus.cn from China; athome.co.jp, homes.co.jp and suumo.jp from Japan; realty.daum.net and new.land.naver.com from South Korea; foxtons.co.uk, rightmove.co.uk and zoopla.co.uk from the United Kingdom; and redfin.com and zillow.com from the United States.

### BRIEF SUMMARY OF THE INVENTION

We present a summary that simplifies the invention, so as to offer the reader some insights into some aspects of the claimed subject matter. The summary is not intended to be a comprehensive overview, and its intention is not to fully delineate the scope of the invention, nor to identify critical or key functionality or steps of the invention. The purpose of the summary is to outline some concepts in a form that is easier to read for a person of ordinary skill in the art. The reader should consult the invention disclosure for details.

Embodiments of the invention include the following methods.
1. A method for searching or comparing at least two points, using travel within a transportation system by at least two entities, the method comprising:
   (a) receiving a request comprising at least one commute path,
      i. wherein a commute path included in the at least one commute path, includes a specification of travel within the transportation system by two or more entities included in the at least two entities,
      ii. wherein the specification specifies travel between at least one pair of points included in the at least two points,
      iii. wherein the at least one pair includes at least one junction, and
      iv. wherein each junction included in the at least one junction, specifies a plurality of entities, that travel to the junction or travel from the junction, and each of the plurality of entities is included in the two or more entities;
   (b) determining at least one description of travel within the transportation system of the at least one commute path; and
   (c) responding to the request with a result of searching or comparing obtained using the at least one description of travel.
2. A method for searching or comparing at least three points, using travel within a transportation system, the method comprising:
   (a) receiving a request comprising an optimization problem that includes at least one commute path,
      i. wherein each commute path included in the at least one commute path, specifies travel within the transportation system, between at least one pair of points included in the at least three points;
   (b) solving the optimization problem, using an approach that includes:
      i. an enumeration search,
      ii. a tree search,
      iii. a gradient descent search,
      iv. a branch-and-bound search, or
      v. an Operations Research search,
      wherein an optimization goal included in the optimization problem depends on at least one description of travel within the transportation system of the at least one commute path; and
   (c) responding to the request with a result of searching or comparing obtained using the at least one description of travel.
3. A method for searching or comparing at least three points, using travel within a transportation system, the method comprising:
   (a) receiving a request comprising an optimization problem that includes at least one commute path,
      i. wherein each commute path included in the at least one commute path, specifies travel within the transportation system, between at least one pair of points included in the at least three points, and
      ii. wherein each of one or more free points included in the at least one pair, is free to be selected in at least two ways, among the at least three points;
   (b) determining at least one point N among the one or more free points, making each point N not free, and determining at least one point F among the remaining free points, wherein the at least one commute path excludes any direct travel between any point included in the at least one point F and any remaining free point not included in the at least one point F;
   (c) solving the optimization problem, using an approach that includes:
      i. selecting a concrete point, for each of the at least one point N, and
      ii. solving an optimization subproblem included in the optimization problem, by selecting a concrete point, for each of the at least one point F,
      wherein an optimization goal included in the optimization problem depends on at least one description of travel within the transportation system of the at least one commute path; and
   (d) responding to the request with a result of searching or comparing obtained using the at least one description of travel.
4. A method for searching or comparing at least two points, using travel within a transportation system, the method comprising:
   (a) receiving a request comprising an optimization problem that includes at least one commute path, that includes a specification of travel within the transportation system between a point P, and a free point F that is free to be selected in at least two ways, among the at least two points;
   (b) determining
      i. at least one nearby representative, or
      ii. at least one nearby point included in the at least two points, that is near the point P;
   (c) generating a modified subproblem based on the optimization problem, by removing the specification of travel, and instead:
      i. adding a specification of modified travel between the free point F and a nearby representative included in the at least one nearby representative, or
      ii. specifying that a nearby point is selected for the free point F, wherein the nearby point is included in the at least one nearby point;
   (d) solving the optimization problem, using an approach that includes solving the modified subproblem,
      wherein an optimization goal included in the optimization problem depends on at least one description of travel within the transportation system of the at least one commute path; and
   (e) responding to the request with a result of searching or comparing obtained using the at least one description of travel.
5. A method for searching or comparing at least two points, using travel within a transportation system, the method comprising:
   (a) receiving a request comprising an optimization problem that includes at least one commute path, that includes a specification of travel within the transportation system, wherein the specification of travel includes at least one free point, each is free to be selected in at least two ways, among the at least two points;
   (b) determining a free point H included in the at least one free point, and determining a concrete point H₂ distinct from a concrete point H₁, each can be selected for the free point H, such that a length of travel between the concrete point H₁ and the concrete point H₂ is at most a threshold;
   (c) solving the optimization problem, using an approach that skips examining any selection of the concrete point H₂ for the free point H,
      wherein an optimization goal included in the optimization problem depends on at least one description of travel within the transportation system of the at least one commute path; and
   (d) responding to the request with a result of searching or comparing obtained using the at least one description of travel.

Embodiments of the invention also include a computer system and an apparatus that realize any of the above methods.

The embodiments of the invention presented in the invention disclosure are for illustrative purpose; they are not intended to be exhaustive. Many modifications and variations will be apparent to those of ordinary skill in the art, without departing from the scope and spirit of the embodiments.

In the presentation, the terms “the first”, “the second”, “the”, and similar, are not used in any limiting sense, but for the purpose of distinguishing, unless otherwise is clear from the context. An expression in a singular form includes the plural form, unless otherwise is clear from the context. An expression in a plural form includes the singular form, unless otherwise is clear from the context. The terms “having”, “including”, “comprising”, and similar, indicate an existence of components or features, and do not preclude other components or features from existing or being added, unless otherwise is clear from the context. The terms “method”, “approach”, “search”, “algorithm”, “process”, and similar, indicate acts or actions that define a manner or a process of making or using, an invention or a part of an invention, and these terms may be used synonymously.

### BRIEF DESCRIPTION OF DRAWINGS

The drawings included in the invention disclosure exemplify various features or advantages of some embodiments of the invention:

FIG. 1: depicts example commute paths: from a home (0101) to a school (0102) by a child (0105), and from a home (0101) to a work (0103) by an adult (0104); and reversed; from a school (0102) to a home (0101) by a child (0105), and from a work (0103) to a home (0101) by an adult (0104);

FIG. 2: depicts example commute paths: (0205) from a home (0201) to a school (0202) jointly by a child (0204) and an adult (0203); (0206) from a school (0202) to a home (0201) by an adult (0203); (0207) from a home (0201) to a school (0202) by an adult (0203); and; (0208) from a school (0202) to a home (0201) jointly by a child (0204) and an adult (0203);

FIG. 3: depicts example commute paths: from a home (0301) to a school (0302) jointly by a child (0305) and an adult (0304), and then from the school (0302) to a work (0303) by the adult (0304); and reversed; from a work (0303) to a school (0302) by an adult (0304), and then from the school (0302) to a home (0301) jointly by a child (0305) and the adult (0304);

FIG. 4: depicts example commute paths: from a home (0401) to a work (0402) jointly by a child (0405) and an adult (0404), and then from the work (0402) to a school (0403) by the child (0405); and reversed; from a school (0403) to a work (4302) by a child (0405), and then from the work (0402) to a home (0401) jointly by the child (0405) and an adult (0404);

FIG. 5: depicts an example commute path: from a home (0501) to a school (0502) by a child;

FIG. 6: depicts an example commute path: from a school (0602) to a home (0601) by a child;

FIG. 7: depicts an example commute path: from a home (0701) to a work (0702) by an adult;

FIG. 8: depicts an example commute path: from a work (0802) to a home (0801) by an adult;

FIG. 9: depicts an example commute path: from a home (0901) to a junction (0902) jointly by a child and an adult, and then from the junction (0902) to a school (0903) by a child, and from the junction (0902) to the home (0901) by the adult;

FIG. 10: depicts an example commute path: from a school (1003) to a junction (1002) by a child, and from a home (1001) to the junction (1002) by an adult, and then from the junction (1002) to the home (1001) jointly by the child and the adult;

FIG. 11: depicts an example commute path: from a home (1101) to a junction (1102) jointly by a child and an adult, and then from the junction (1102) to a work (1103) by the adult, and from the junction (1102) to a school (1104) by the child;

FIG. 12: depicts an example commute path: from a school (1203) to a junction (1204) by a child, and from a work (1202) to the junction (1204) by an adult, and then from the junction (1204) to a home (1201) jointly by the child and the adult;

FIG. 13: depicts an example commute path: from a home (1301) to a junction (1302) jointly by a child and an adult, and then from the junction (1302) to a school (1303) by the child, and from the junction (1302) to a work (1304) by the adult, and then from the school (1303) to a junction (1305) by the child, and from the work (1304) to the junction (1305) by the adult, and then from the junction (1305) to the home (1301) jointly by the child and the adult;

FIG. 14: depicts an example commute path: from a home (1401) to a junction (1402) jointly by a child and an adult, and then from the junction (1402) to the home (1401) by the adult, and from the junction (1402) to a school (1403) by the child, and then from the school (1403) to a junction (1404) by the child, and from the home (1401) to the junction (1404) by an adult, and then from the junction (1404) to the home (1401) jointly by the child and the adult;

FIG. 15: depicts an example commute path: from a home (1501) to a junction (1502) jointly by a child and an adult, and then from the junction (1502) to a school (1504) by the child, and from the junction (1502) to a work (1503) by the adult, and from the work (1503) to the home (1501) by the adult, and then from the school (1504) to a junction (1506) by the child, and from the home (1501) to a work (1505) by an adult, and from the work (1505) to the junction (1506) by the adult, and then from the junction (1506) to the home (1501) jointly by the child and the adult;

FIG. 16: depicts an example commute path: from a home (1601) to a junction (1603) by an adult (1606), and then from the junction (1603) to a work (1604) by the adult (1606), and then from the work (1604) to the home (1601) by the adult (1606), and from a home (1602) to the junction (1603) by an adult (1607), and then from the junction (1603) to a work (1605) by the adult (1607), and then from the work (1605) to the home (1602) by the adult (1607);

FIG. 17: depicts example min-structures for two trees that partition junctions: the node (1701) is tagged with 5, that is a minimum travel duration, from a home (1705) to any junction in the area associated with the node (1701); the node (1702) has a smaller tag of 4, because of a shorter minimum travel duration; the node (1703) is tagged with 5, that is a minimum sum of two constituent travel durations, from a junction to a school (1706), plus from the junction to a work (1707), minimized across any junction in the area associated with the node (1703); the node (1704) has a larger tag of 9, because of a larger minimum sum, in the area associated with the node (1704); the tags of the four home-to-junction nodes are minimized up to a parent node (1708); the tags of the four junction-to-school-and-work nodes are minimized up to a parent node (1709);

FIG. 18: depicts an example User Interface of an apparatus: the apparatus receives a request, which specifies a requirement for: real estate properties (1801), works (1802), schools (1803), and commute paths (1804), (1805), where: an adult T1 travels to a provided work W₁, a child L2 travels to a provided school S₂, an adult T2 travels to a freely selected work, but the work must match the specified Curriculum Vitae (1802), and a child L1 travels to a freely selected school, but the school must match the specified exam results (1803), and the child L1 must travel to the school jointly with an adult (1804); in response, the apparatus presents a result of searching or comparing, including: descriptions of travel of the commute paths (1806), travel durations (1807), information about selected homes (1808), selected schools (1809), and selected works (1810), and a representation of the information as profit (such as, salary minus rent) (1811); and

FIG. 19: depicts an example sparsification: a subproblem S includes a commute path for travel from a concrete P, to a free point [symbol] , and then to a concrete Q; any of the concrete F_{,1}, F_{,2} or F_{,3} can be selected for the free point [symbol] ; near the P, there is one concrete F_{,1} that can be selected for the free point [symbol] ; near the P, there are two concrete representatives R_{,1} and R_{,2}; a recursive step of the sparsification, generates three modified subproblems: (1) a modified subproblem M1, that includes a commute path from the concrete R_{,1}, to the free point [symbol] , and then to the concrete Q, (2) a modified subproblem M2, that includes a commute path from the concrete R_{,2}, to the free point [symbol] , and then to the concrete Q, and (3) a modified subproblem M3, that includes a commute path from the concrete F_{,1} to the concrete Q.

The drawings are for illustrative purpose only. Other drawings can exemplify the invention, without departing from the scope and spirit of the embodiments, as will be readily recognized by one of ordinary skill in the art.

### DETAILED DESCRIPTION OF THE INVENTION

The invention has a general purpose of searching or comparing points, based on an optimization goal that uses travel of at least one entity among some of the points within a transportation system. However, for the sake of ease of explanation, we first illustrate the invention through narrower embodiments of a real estate search engine, where: the points include: a home, a work or a school; and where the entities include: at least one adult, each of whom may commute to a work, or at least one child, each of whom may commute to a school, and who may travel jointly with an adult during a commute to the school. However, this illustration is not limiting. Those of ordinary skill in the art will notice that the invention concerns the general purpose, without departing from the scope and spirit of the embodiments. Later, we illustrate the invention through broader embodiments.

### 1 Introduction

We use the term point in a broad sense, consistent with an interpretation of the term by a person of ordinary skill in the art. A point includes in its scope a point of interest (POI) that is common in the art. Any point has a location. The location may, or may not, be stationary. A point could be just a location. Examples of a point include: a geographic location, a real estate property, a home, a work, a school, a private school, a public school, a school gate, a school door, a building door, a work door, a company gate, a public transportation stop, a transit stop, a bus stop, a stop of a school bus, a subway station, an airport, a vehicle stop, a vehicle embarkation or disembarkation location, a transfer location, a road intersection, a walk pathway intersection, a subway entrance or exit, a highway entrance or exit, a parking lot, a senior citizen center, a park, a hospital, a clinic, a pharmacy, a restaurant, a shop, a supermarket, a convenience store, a laundry service, a piano class, a storage facility, a sorting facility, a logistics hub, a bank, an ATM, a government office, a crime report, a police station, or a military base. Many other examples of a point will be apparent to one of ordinary skill in the art, without departing from the scope and spirit of the embodiments. In the invention disclosure, we may recite any of the examples of a point, but, in one embodiment, it should be understood that we mean a point in general. For example, we may recite “a home”, but we mean a point. Reciting a certain example helps distinguish terms. In one embodiment, a point represents a cluster of nearby points, such as within 1000 meters, or 1 minute of travel. For example, a point is a centroid of the cluster. In one embodiment, a point represents, a location that often occurs in shortest travel from certain points, or, when travel is in the opposite direction, a location that often occurs is shortest travel to certain points. Such certain points could be: homes, or could be schools, or could be works, etc. Such locations are sometimes called representatives, and the locations can be computed using prior art, for example: as “transit stations” described by U.S. Pat. No. 8,417,409; as “global stations” described by U.S. Pat. No. 8,756,014; as “hubs” described by Gavoille, Peleg, Perennes and Raz: “Distance Labeling in Graphs”, Journal of Algorithms, Vol. 53 2004; as “carefully selected points” described by Sommer: “Shortest-Path Queries in Static Networks”, ACM Computing Surveys, Vol. 46(4) 2014; or as a “sparse shortest-path hitting set” described by Abraham, Delling, Fiat, Goldberg and Werneck: “Highway Dimension and Provably Efficient Shortest Path Algorithms”, Journal of the ACM, Vol. 63(5) 2016. In one embodiment, a point P is interpreted using at least one point associated with the point P. For example, a home is interpreted as any transit stop near the home, or a school is interpreted as a school gate of the school, or a school is interpreted as any stop of a school bus of the school, or a work is interpreted as any parking lot near the work. In one embodiment, a travel duration between a point P and a location Q, is determined using a travel duration via any such associated point, or is determined as a travel duration between any such associated point and the location Q. While this invention disclosure may recite a point, it should be understood that, in one embodiment, the point represents any embodiment recited in the instant paragraph.

We use the term travel in a broad sense, consistent with an interpretation of the term by a person of ordinary skill in the art. The term has a meaning that includes moving an entity, such as: an object, an item, data, cargo, a vehicle, a delivery vehicle, a person, an adult, a child, a patron, a sibling, an animal, a dog, a courier, a package, a parcel, a message, a letter, or a shopping basket. Many other examples of an entity will be apparent to one of ordinary skill in the art, without departing from the scope and spirit of the embodiments. In the invention disclosure, we may recite any of the examples of an entity, but, in one embodiment, it should be understood that we mean an entity in general. For example, we may recite “an adult”, but we mean an entity. Reciting a certain example helps distinguish terms. A description of travel is anything that a person of ordinary skill in the art would name so. Here are some examples of a description of travel: (1) “hey buddy, you need to go one block north, and then turn slightly left”, and (2) “5 dollars”. A length of travel is a numeric value that a person of ordinary skill in the art can associate with travel, for example: a monetary cost of travel; a metric distance; a fuel consumption; a certain feature or attribute of a description of travel, for example: a number of transfers, or a walking distance. As other example, we may use a term travel duration when we mean a length of travel that represents time. A length of travel is by itself a description of travel. A description of travel: may not include any length of travel, may include only a length of travel, or may also include some other data.

We use the term transportation system in a broad sense, consistent with an interpretation of the term by a person of ordinary skill in the art. Some embodiments include: a system of roads and cars; a public transit system comprising buses and subways; a system of walk pathways; airports, airplanes and air corridors; or ships and sea lanes. A transportation system that moves data, is an example of a transportation system, such as a computer network, comprising these components, or transportation elements: wires/lines/fibers (analogous to roads), and hubs/switches (analogous to stops/turns). A transportation system may, or may not, physically move objects. Any combination of transportation systems allowing for a transfer among them is a transportation system. Many other examples of a transportation system will be apparent to one of ordinary skill in the art, without departing from the scope and spirit of the embodiments.

The invention disclosure determines a description of travel within a transportation systems between two endpoint locations, using any manner that could be used by a person of ordinary skill in the art. For example, using any prior art shortest paths algorithm, such as Dijkstra's, Bellman-Ford or A*, on a graph that models a transportation system; using any shortest paths approximation algorithm; using any prior art method for computing a route, such as any approach described in Bast, Delling, Goldberg, Müller-Hannemann, Pajor, Sanders, Wagner and Werneck: “Route planning in transportation networks”, Algorithm engineering: Selected results and surveys, 2016; or using any method of our earlier invention disclosures: PCT/US2019/017909, PCT/US2021/029024, or PCT/US2021/065165, for example where the two endpoint locations correspond, in some order, to a site and a place, or to a source location and a target location, recited in said earlier invention disclosures. In one embodiment, we determine a plurality of descriptions of travel, for example using any one-to-many, or any batched, shortest paths method known in the art, such as Delling, Goldberg and Werneck: “Faster Batched Shortest Paths in Road Networks”, 11th Workshop on Algorithmic Approaches for Transportation Modeling, Optimization, and Systems 2011, or any method of said earlier invention disclosures, and then we use a relevant such description of travel in a relevant part of our method. Thereby, one plurality can be reused several times. In one embodiment, our methods determine a minimum length of travel between any two endpoint locations. However, when we say that a length of travel is minimized, it should be understood that, in one embodiment, a length of travel is not minimized, for example when a shortest paths approximation algorithm, or a heuristic, is used to compute a minimum length of travel between the two endpoint locations.

We use the term precomputing in a broad sense, consistent with an interpretation of the term by a person of ordinary skill in the art. In one embodiment, we precompute a description of travel for at least one pair of endpoint locations, and store it in a storage medium before the request is received, and then retrieve a precomputed description of travel from the storage medium, and use it during request processing, rather than computing the description of travel after the request is received. In one embodiment, a method precomputes fragments of descriptions of travel, stores them in a storage medium, and later uses them. This can be done in many ways. In one embodiment, a method determines a coarsened graph, which is obtained from a graph that models a transportation system, using any graph coarsening approach known in the art. In one example, an edge of a coarsened graph is a shortcut graph edge determined using an approach described by Geisberger, Sanders, Schultes and Delling: “Contraction Hierarchies: Faster and Simpler Hierarchical Routing in Road Networks”, Workshop on Experimental and Efficient Algorithms 2008. In other example, a coarsened graph is obtained using any graph summarization approach known in the art, for example, described in a survey paper by Liu, Safavi, Dighe and Koutra: “Graph Summarization Methods and Applications: A Survey”, ACM Computing Surveys, Vol. 51(3) 2018. Later, we compute a description of travel within a transportation system between two endpoint locations, by considering a path within a coarsened graph, and by combining at least one fragment of a description of travel along the path, such as two shortcuts, or two edges within a graph summary. Thus, in one embodiment, precomputing is simply an activity performed before request processing, so as to make the request processing more efficient.

We use the term searching or comparing in a broad sense, consistent with an interpretation of the term by a person of ordinary skill in the art. For example, the method searches for a home, a work, or a school that minimizes a travel duration. For example, the method compares: two homes based on travel duration, two schools based on travel duration, two works based on travel duration, two homes that have a similar travel duration based on their price, two schools that have a similar travel duration based on their position in a school ranking, or two works within a 1-hour commute based on job compensation. The term includes in its scope a route planning, such as in a navigation engine, for example by Google Maps, for example where the start and the end of a route correspond to the endpoints of a description of travel. The term also includes in its scope a delivery planning, such as in a delivery system, for example of Amazon, FedEx or Meituan, for example where the sorting facility location and the delivery location for a courier correspond to the endpoints of a description of travel. The term also includes in its scope a corporate real estate planning, such as determining a location of a corporation based on commutes of its employees, for example from the home locations of the employees. Other embodiments include these recited in any of said earlier invention disclosures. In general, searching or comparing can be characterized as a process that includes achieving an optimization goal, that is based on: (1) at least two points, and (2) a description of travel within a transportation system between at least one pair of the points. Many other examples of searching or comparing will be apparent to one of ordinary skill in the art, without departing from the scope and spirit of the embodiments.

### 2 Exemplary Embodiment

We describe an exemplary embodiment of the invention. In one embodiment, the method obtains information about points, such as homes, schools or works, from at least one data source, for example pertaining to a certain metropolitan area. The information includes locations of the points. In one embodiment, the method obtains information about at least one transportation system from at least one data source, for example: schedules of buses or subways and locations of vehicle stops, or roads or walk pathways and their locations. Any such obtaining can be viewed as an act of measuring the real world. Any such measurement is then used by any of our methods to produce a result of searching or comparing.

### 2.1 Request

In one embodiment, the method receives a request that includes at least one commute path. Each commute path includes at least one pair of points. Each pair specifies endpoint locations of travel by at least one entity. For example, a commute path specifies: an adult travels from a home to a work. In one embodiment, a number of pairs of points, is at least a predetermined threshold, or is at most a predetermined threshold, such as a threshold of 2 or a threshold of 10. In one embodiment, a pair specifies travel between the same two points, or specifies travel between two different points. The request may exclude some commute paths, for example to ensure patentability with respect to prior art.

In one embodiment, the request includes a requirement. We use the term requirement in a broad sense, consistent with an interpretation of the term by a person of ordinary skill in the art. The requirement specifies an optimization problem, that includes an optimization goal. In one embodiment, a requirement specifies a restriction on travel along a commute path, such as: use walk only, use car only, use public transit only, use a school bus, use a certain school gate, use any of at least one school gate, depart from a point at a certain time, arrive at a point before a certain deadline (for example, based on a ride schedule of a school bus), find a fastest travel given current traffic conditions, find a fastest travel given average traffic conditions, find a cheapest travel, or travel some number of times, such as five times per week. In one embodiment, a requirement specifies a restriction on at least one point, such as: a home must have an area in a range between 80 and 90 square meters, a work must match qualifications of an adult, a home or a work is within a school zone of a school, a school for a child should have a high-rank, the child is likely to be admitted based on school admission criteria, or a result should include points that are top-10 according to an optimization goal. In one embodiment, a requirement concerns both travel and at least one point, such as: a home or a work is within 20 minutes of travel by a school bus of a school. In one embodiment, the requirement includes a designation how a travel duration of a commute path is modified. The designation is an arbitrary computable function (in the sense of computability theory). For example, the computable function is a piecewise linear function, such as: for a certain threshold T, the computable function maps a travel duration x to T, when x≤T, and maps a travel duration x to ∞, when x>T. In one embodiment, any constituent travel duration of a commute path has a designation that modifies the travel duration of the constituent. A designation allows our method to exclude homes that are too far from work, or exclude a travel duration by a school bus. We may not explicitly mention a designation elsewhere in the invention disclosure. However, it should be understood that, in one embodiment, at least one travel duration is modified based on at least one designation. In one embodiment, a requirement is preset, for example as in a prior request, or to ensure patentability with respect to prior art.

A travel duration of a commute path depends on a selection of concrete points specified by the commute path. For example, consider a commute path: from a home H to a work W, and then back to the home H. Let us assume that in this example, a work W is provided as part of the request (for example, the request prescribes that the work W is located at a geographic location with coordinates 40.7180, −73.9869), and let us assume that a home H is free to be selected arbitrarily (for example, the request prescribes that H can be selected to be any home in Manhattan). For a concrete selection of H (for example, H is selected to be the home at an address 100 Central Park West), we obtain a travel duration of the commute path, by adding the following two constituent travel durations: from the concrete H to the concrete W, and from the concrete W to the concrete H. In general, in a commute path, some of its specified points are provided, and some of its specified points are free. When a point P is provided, then it means that the point P is already concretely selected by the request. When a point P is free, then it means that a concrete P can be selected from a set of points. In one embodiment, a meaning of the set is clear from the context. For example, a concrete home can be selected from the set of all homes. In one embodiment, however, the set is an arbitrary set of points. The set may depend on some points, or on travel among some points. For example, once a concrete school is selected, then only homes in the zone of the school may be selected. For example, once a concrete bus line for a ride to a school is selected, then a ride in the opposite direction from the school must use the same bus line. For example, once a concrete embarkation bus stop B is selected for a ride to a school, then only a disembarkation bus stop near B can be selected for a ride from the school. The set may be empty, for example when a home is outside of a zone of any school, or when a home cannot be reached by car. In one embodiment, the request prescribes which point is free, and which point is provided. In one embodiment, a commute path specifies which of the at least one point included in the commute path is provided, or that no point is provided. In one embodiment, a commute path specifies which of the at least one point included in the commute path is free, or that no point is free. Then, a goal is to select a concrete point, for each free point, so as to achieve an optimization goal.

A travel duration of a commute path is determined using any manner that could be used by a person of ordinary skill in the art. For example, the method determines a constituent travel duration, for each pair of the endpoint locations of the commute path, using any manner that could be used by a person of ordinary skill in the art. The method then adds the constituent travel durations, and the sum is a travel duration of the commute path. In one embodiment, we precompute a travel duration of at least one commute path, for at least one selection of concrete points, and store the travel duration in a storage medium before a request is received, and then retrieve a precomputed travel duration from the storage medium, and use it during request processing, rather than computing the travel duration after the request is received.

In one embodiment, a home is free, but any work is provided. In one embodiment, the method enumerates at least one concrete home, and determines a travel duration of each of at least one commute path, for the concrete home, as described in the subsequent sections. In one embodiment, also any school is free, and when a school is included in a commute path, then, in one embodiment, the method also enumerates at least one concrete school, and determines a travel duration of the commute path, for the concrete home and the concrete school, as described in the subsequent sections. And, the method uses the at least one travel duration to achieve the optimization goal. In one embodiment, the enumerations are subject to the requirement.

### 2.2 Kernel Commute Paths

We describe several types of commute paths. We use the term singular description of travel in the context of travel between two endpoints, when the travel is performed by one entity. We use the term dual description of travel in the context of travel between two endpoints, when the travel is performed jointly by two entities. When referring to travel by at least two entities, the term jointly is interpreted in a broad sense, consistent with an interpretation of the term by a person of ordinary skill in the art. For example, we require, or do not require, the entities to travel: inside the same vehicle, while holding hands when walking, with the dog on a leash, and so on. In one embodiment, a commute path includes travel jointly by at least two entities. In one embodiment, a commute path does not include any travel jointly by at least two entities.

### 2.2.1 Commute Paths: “Work-Only”, and Reversed

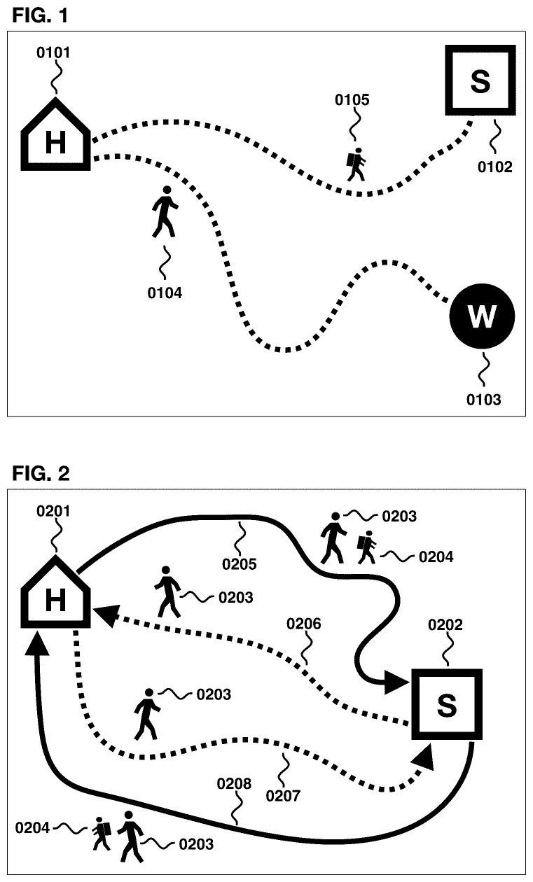

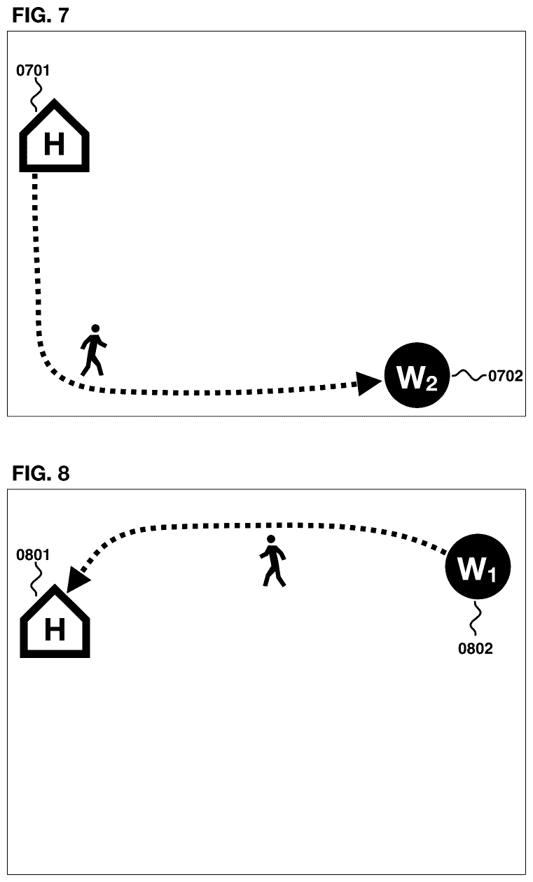

In one embodiment, a commute path is a “work-only” commute path (examples are in FIG. 1 and FIG. 7), where:
(a singular description of travel) an adult travels from a home to a work.

A travel duration of the commute path is determined using any manner that could be used by a person of ordinary skill in the art. In one embodiment, we compute a travel duration using said earlier invention disclosures, where a home corresponds to a site, and a work corresponds to a place.

In one embodiment, a commute path is a reversed “work-only” commute path (an example is in FIG. 8), where an adult travels from a work to a home. Its travel duration is determined in any corresponding manner (reversing the direction of travel).

### 2.2.2 Commute Paths: “School-Only”, and Reversed

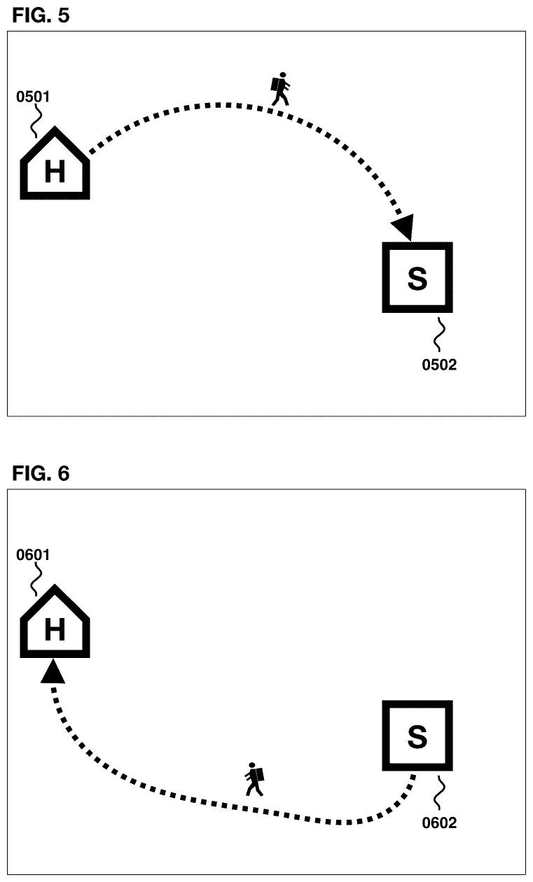

In one embodiment, a commute path is a “school-only” commute path (examples are in FIG. 1 and FIG. 5), where:
(a singular description of travel) a child travels from a home to a school.
   In one embodiment, the commute path is interpreted to include a point, such as a school gate or a stop of a school bus, and a child travels from a home to a point, and then from the point to a school. The point may be the same as the school.

A travel duration of the commute path is determined using any manner that could be used by a person of ordinary skill in the art. In one embodiment, a travel duration of the commute path is a sum of the following two constituent travel durations: from a home to a point, and from the point to a school. In one embodiment, we determine a travel duration of the commute path, by finding a concrete point that minimizes the sum, for a concrete home and a concrete school. In one embodiment, we determine a travel duration of the commute path, using any approach for the best via point problem, such as: (1) an approach of double-hub indexing, for example using two hubs: a forward hub from the concrete home, and a reverse hub to the concrete school; or (2) an approach of double-source indexing, for example using a bucket B(v, w) for a shortcut (v, w) in a cell, such that the bucket contains the best concrete point, as if: v was the concrete home, w was the concrete school, and the cell was the entire graph. In one embodiment, a designation dictates that a travel duration D between a point and a school, is excluded from a travel duration of the commute path (so, the travel duration D is not included in the sum).

In one embodiment, a commute path is a reversed “school-only” commute path (an example is in FIG. 6), where a child travels from a school to a home. Its travel duration is determined in any corresponding manner.

### 2.2.3 Multiplicity

In one embodiment, a travel duration is counted at a multiplicity, such as: a multiplicity of the number of entities who travel jointly, a multiplicity of the cost of travel, a multiplicity of zero (number 0), or a multiplicity not equal one (number 1). For example, when travel is performed jointly by an adult and a child, then the travel duration is counted once. Each travel between two endpoints may use a multiplicity; each travel may use a multiplicity different from a multiplicity used by other travel.

In one embodiment, a requirement specifies a manner of counting travel durations. In one embodiment, a manner is preset, for example as in a prior request, or to ensure patentability with respect to prior art.

We may not explicitly mention a multiplicity elsewhere in the invention disclosure. However, it should be understood that, in one embodiment, any travel duration is determined based on at least one multiplicity.

### 2.2.4 Commute Paths: “School-Back”, and Reversed

In one embodiment, a commute path is a “school-back” commute path (an example is in FIG. 2), where:
(a dual description of travel) both an adult and a child travel jointly from a home to a school, for example, the adult transports the child to school, and then
(a singular description of travel) the adult continues traveling without the child from the school to the home.
   In one embodiment, the commute path is interpreted to include a point, such as a school gate or a stop of a school bus, and both an adult and a child travel jointly from a home to a point, then the child continues traveling from the point to a school, and the adult continues traveling from the point to the home. The point may be the same as the school.

A travel duration of the commute path is determined using any manner that could be used by a person of ordinary skill in the art. In one embodiment, a travel duration of the commute path is a sum of the following three constituent travel durations: from a home to a point, from the point to a school, and from the point to the home. In one embodiment, we determine a travel duration of the commute path, by finding a concrete point that minimizes the sum, for a concrete home and a concrete school. In one embodiment, a designation dictates that a travel duration between a point and a school is excluded from a travel duration of the commute path.

In one embodiment, we determine a travel duration of the commute path, by extending any approach for the best via point problem. For example, we extend the approach of double-hub indexing. We examine a meeting hub that each shortest travel must pass, on the way to or from the point. Any such hub is a forward hub or a reverse hub of the point, based on the direction of travel. In the current case, we examine three hubs: a forward hub b_{h→*} from the concrete home, a reverse hub b_{*→h} to the concrete home, and a reverse hub b_{*→s} to the concrete school. We also use the remainder travel between the examined hubs and the point. In the current case, we use the following travel: from the hub b_{h→*} to the point, from the point to the hub b_{*→h}, and from the point to the hub b_{*→s}. And then we find a concrete point and concrete hubs, that minimize a travel duration of the commute path. In the current case, we find a concrete point p, and concrete hubs b_{h→*}, b_{*→h} and b_{*→s}, that minimize a sum of the following six constituent travel durations: (1) from the concrete home to the concrete b_{h→*}, (2) from the concrete b_{*→h} to the concrete home, (3) from the concrete b_{*→s} to the concrete school, (4) from the concrete b_{h→*} to the concrete p, (5) from the concrete p to the concrete b_{*→h}, and (6) from the concrete p to the concrete b_{*→s}. In one embodiment, for at least one tuple of the concrete hubs, we precompute a concrete point p, that minimizes a sum of the constituent travel durations that are incident with the point, and store the sum in a storage medium before the request is received, and then retrieve a precomputed sum from the storage medium, and use it during request processing, rather than computing a sum after the request is received. In the current case, we precompute a concrete point p, that minimizes a sum of the following three travel durations: from the concrete b_{h→*} to the concrete p, from the concrete p to the concrete b_{*→h}, and from the concrete p to the concrete b_{*→s}. Although the above extension of the double-hub indexing, was presented in the context of a specific commute path with one point, this presentation is not limiting. It should be understood, that the above extension, similarly applies to any commute path that includes at least one point. We extend other approaches for the best via point problem in a similar manner. In one embodiment, an extension of an approach is preset, for example as in a prior request, or to ensure patentability with respect to prior art.

In one embodiment, a commute path is a reversed “school-back” commute path (an example is in FIG. 2), where an adult travels from a home to a school, and then both the adult and a child travel jointly from the school to the home. Its travel duration is determined in any corresponding manner.

### 2.2.5 Commute Paths: “School-First”, and Reversed

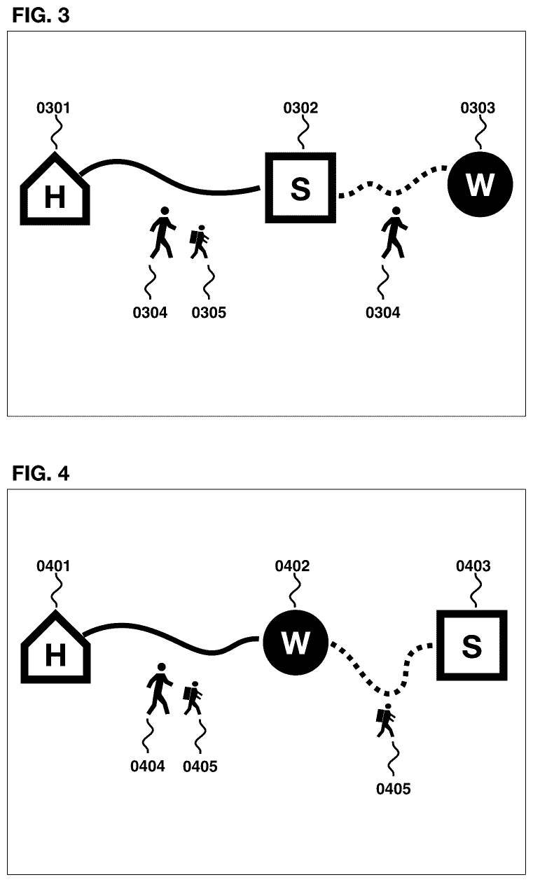

In one embodiment, a commute path is a “school-first” commute path (an example is in FIG. 3), where
(a dual description of travel) both an adult and a child travel jointly from a home to a school, for example, the adult walks the child to school, and then
(a singular description of travel) the adult continues traveling without the child to a work.
   In one embodiment, the commute path is interpreted to include a point, such as a school gate or a stop of a school bus, and both an adult and a child travel jointly from a home to a point, then the child continues traveling from the point to a school, and the adult continues traveling from the point to a work. The point may be the same as the school.

A travel duration of the commute path is determined using any manner that could be used by a person of ordinary skill in the art. In one embodiment, a travel duration of the commute path is a sum of the following three constituent travel durations: from a home to a point, from the point to a work, and from the point to a school. In one embodiment, we determine a travel duration of the commute path, by finding a concrete school that minimizes the sum, for a concrete home and a concrete work. In one embodiment, we determine a travel duration of the commute path, by finding a concrete point that minimizes the sum, for a concrete home, a concrete work, and a concrete school. In one embodiment, we use said earlier invention disclosures, where a point corresponds to a site, and a work corresponds to a place, or where a school corresponds to a site, and a work corresponds to a place.

In one embodiment, a commute path is a reversed “school-first” commute path, where an adult travels from a work to a school or a point, and then both the adult and a child travel jointly to a home. Its travel duration is determined in any corresponding manner.

### 2.2.6 Commute Paths: “Work-First”, and Reversed

In one embodiment, a commute path is a “work-first” commute path (an example is in FIG. 4), where:
(a dual description of travel) both an adult and a child travel jointly from a home to a work, and then
(a singular description of travel) the child continues traveling without the adult to a school, for example, the child walks to school.
   In one embodiment, the commute path is interpreted to include a point, such as a school gate or a stop of a school bus, and the child travels without the adult from the work to the point, and then from the point to a school. The point may be the same as the school.

A travel duration of the commute path is determined using any manner that could be used by a person of ordinary skill in the art. In one embodiment, a travel duration of the commute path is a sum of the following three constituent travel durations: from a home to a work, from the work to a point, and from the point to a school. In one embodiment, we determine a travel duration of the commute path, by finding a concrete school that minimizes the sum, for a concrete home and a concrete work. In one embodiment, we determine a travel duration of the commute path, by finding a concrete point that minimizes the sum, for a concrete home, a concrete work and a concrete school. In one embodiment, we use said earlier invention disclosures, where a home corresponds to a site, and a work corresponds to a place; or where a school corresponds to a site, and a work corresponds to a place; or where a point corresponds to a site, and a work corresponds to a place.

In one embodiment, a commute path is a reversed “work-first” commute path, where a child travels from a school to a work, and then both an adult and the child travel jointly from the work to a home. Its travel duration is determined in any corresponding manner.

### 2.2.7 Junction

A junction is an arbitrary point, to where at least two entities travel (for example, at least one entity, or each entity, travels from a different point, and then arrives at the junction, aka a “join”), or from where at least two entities travel (for example, at least one entity, or each entity, departs from the junction, and then travels to a different point, aka a “fork”), or both (aka a “rendezvous”). In one embodiment, a junction is: a home, a work, a school, a school gate, or a stop of a school bus. In one embodiment, a junction is an arbitrary location. Junctions may reflect several practical scenarios. For example, a junction reflects a scenario where an adult walks jointly with a child from a home to a stop of a school bus, and then the child continues to a school by bus, and the adult walks back home, or a junction reflects a scenario where a courier hands over a package to other courier at a sorting facility.

In one embodiment, at least one junction satisfies a restriction. We use the term restriction in a broad sense, consistent with an interpretation of the term by a person of ordinary skill in the art. We list several examples next. In one embodiment, the entities arrive at a junction at arbitrary times. In one embodiment, the entities depart from a junction at arbitrary times. In one embodiment, the entities arrive or depart at the same time. In one embodiment, a certain entity arrives or departs before some other entity arrives or departs. In one embodiment, a restriction specifies a time of arrival or a time of departure of at least one entity. In one embodiment, a commute path includes no junction. In one embodiment, a commute path includes at least one junction. In one embodiment, a commute path includes a travel jointly by at least two entities before or after a junction. In one embodiment, a commute path does not include any travel jointly by at least two entities before or after a junction. In one embodiment, a junction is, or is not, a first location on a commute path. In one embodiment, a junction is, or is not, a last location on a commute path. In one embodiment, a junction is included in an arbitrary set of points, for example a junction is a home, or a school, or a work. In one embodiment, a junction is excluded from an arbitrary set of points, for example, a junction is neither a home, nor a school, nor a work. In one embodiment, we exclude at least one location from consideration for a junction, or limit a junction to be one of at least one location. For example, a junction is: (a) any location inside a convex hull, whose corners are the locations of some points included in a commute path (such as a home, a school, and a work); or (b) any location that is near the convex hull, for example at most a threshold away from the convex hull, for example at most 1000 meters, or 5 minutes of travel. In one embodiment, a junction is computed independently of at least one of the corners. For example, a junction is: (a) a location that minimizes a travel duration between the junction and the school; (b) a location that minimizes a travel duration between the junction and the home; (c) a location that minimizes a travel duration between the junction and the work; or (d) a location that minimizes a sum of at least two of the above travel durations. In one embodiment, the specifics of a transportation system exclude at least one location from consideration for a junction. For example: a junction is restricted based on where it is feasible for the adult and the child to join travel or to fork travel, a junction is restricted to be one of the stops of a school bus of the school, a junction is restricted to be one of the gates of the school, or a junction is restricted to be one of the locations where it is safe for the child to board or disembark a car. In one embodiment, a restriction is a combination of at least one restriction. In one embodiment, the request specifies a restriction on at least one junction. In one embodiment, a restriction for at least one junction is preset, for example as in a prior request, or to ensure patentability with respect to prior art.

### 2.2.8 Commute Path: “Junction-Continue”

In one embodiment, a commute path is a “junction-continue” commute path (an example is in FIG. 11), where:
(a dual description of travel) both an adult and a child travel jointly from a home to a junction, and then
(a singular description of travel) the child continues traveling from the junction to a school, and the adult continues traveling from the junction to a work.
   In one embodiment, a junction reflects a scenario where an adult walks jointly with a child from a home to a stop of a school bus, or to a gate of a school, and then the child continues to a school, and the adult continues to a work. In one embodiment, a junction reflects a scenario where an adult drives jointly with a child from a home to a disembarkation location, for example near a school, and then the child walks to the school, and the adult continues driving to a work. In one embodiment, a junction reflects a scenario where, an adult transports a child from a home to a gate of a work or a parking lot near a work, and then the child continues to a school, and the adult continues to the work.

A travel duration of the commute path is determined using any manner that could be used by a person of ordinary skill in the art. In one embodiment, a travel duration of the commute path is a sum of the following three constituent travel durations: from a home to a junction, from the junction to a school, and from the junction to a work. In one embodiment, we determine a travel duration of the commute path, by finding a concrete junction that minimizes the sum, for a concrete home, a concrete school and a concrete work. In one embodiment, a designation dictates that a travel duration between a junction and a school is excluded from a travel duration of the commute path.

In one embodiment, we find a junction using an enumeration search. We examine at least one concrete junction, determine a travel duration of the commute path via the junction, and find a concrete junction that minimizes the travel duration.

In one embodiment, we find a junction using a tree search. For example, (a) we build 3 shortest-path trees in a graph that models a transportation system, based on a direction of travel: a tree forward from a home, a tree reverse from a school, and a tree reverse from a work, at least one graph vertex has a travel duration in each tree, and (b) we find a graph vertex that minimizes a sum of the 3 constituent travel durations in the 3 shortest-path trees. The graph vertex represents a junction that minimizes the sum.

In one embodiment, we find a junction using a gradient descent search. We start at an arbitrary junction J. Then, we determine travel durations of the commute path via junctions near J, for example: junctions in a neighborhood of a predetermined radius around J, such as 1000 meters, or 5 minutes of travel; junctions in a neighborhood of a size at most a threshold, such as 10 junctions; junctions in a neighborhood that includes a nearest junction other than J; or junctions in a neighborhood of a predetermined radius above a travel duration between J and a nearest other junction. Then, we find a junction J′ that yields a shortest travel duration near J. If that travel duration is shorter than the travel duration via J, then we set J to J′, and continue the search. Else, we stop the gradient descent search. Then, the junction found by the search, is considered to be the J; the J may not actually minimize the sum.

In one embodiment, we find a junction using a branch-and-bound search. The following description uses an arbitrary work W, an arbitrary school S, and an arbitrary home H; this use is not limiting.

In one embodiment, we process junctions according to a sequence, based on at least one of the 3 constituent travel durations. For example, according to a travel duration from H to each junction. We process the travel durations in an arbitrary order, for example monotonically, smallest first. During the processing, we maintain a junction Jₘᵢₙ and a travel duration Dₘᵢₙ. Initially, we set Dₘᵢₙ to an upper bound on the minimum travel duration (the minimum is smaller or equal than the upper bound). Several ways of computing an upper bound are described in the invention disclosure. For example, we set Dₘᵢₙ to infinity. We skip processing a travel duration T, when it is at least Dₘᵢₙ. Else, when processing a travel duration T, we compute the remaining travel duration R. In this example, T is a travel duration from the home H to a junction J, and R is a sum of the following two travel durations: from the junction J to the work W, and from the junction J to the school S. When a sum T+R is smaller than Dₘᵢₙ, then we set Dₘᵢₙ to T+R, and set Jₘᵢₙ to J. Once the processing has finished, the junction found by the search, is considered to be the Jₘᵢₙ. In one embodiment, the Jₘᵢₙ minimizes a travel duration of the “junction-continue” commute path, and the Dₘᵢₙ is that minimum travel duration.

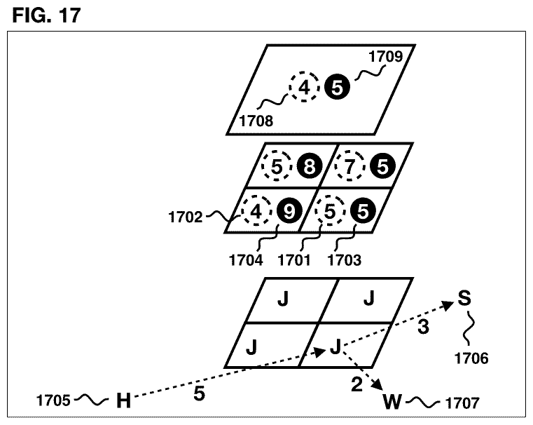

In one embodiment, we use a partitioning of the junctions. For example, we use a hierarchical partitioning of the junctions, where the hierarchy is induced by the inclusion relation. It is helpful to think of a hierarchical partitioning as a tree P. An example is in FIG. 17. Each node of the tree P is associated with a set of junctions. The node is either a leaf of the tree P, or the set of junctions associated with the node is partitioned into at least one subset. Each such subset forms a child of the node in the tree P. Each child is associated with a subset that includes at least one junction. For the sake of ease of explanation, we use a geographical partitioning into areas, where we refer to each area as a square, and the child nodes will be referred to as: TopLeft, TopRight, BottomLeft, and BottomRight. This shape of an area is not limiting; other shapes are used in other embodiments. A partitioning of the junctions is computed using any relevant method known in the art, for example any clustering method, such as: (1) a hierarchical agglomerative clustering (HAC); (2) a hierarchical technique used in computing a route, such as contraction hierarchies (CH) described by Geisberger, Sanders, Schultes and Delling: “Contraction Hierarchies: Faster and Simpler Hierarchical Routing in Road Networks”, Workshop on Experimental and Efficient Algorithms 2008; (3) a graph partitioning, such as PUNCH described by Delling, Goldberg, Razenshteyn and Werneck: “Graph Partitioning with Natural Cuts”, IEEE International Parallel and Distributed Processing Symposium 2011; (4) a graph summarization, such as any approach described by Liu, Safavi, Dighe and Koutra: “Graph Summarization Methods and Applications: A Survey”, ACM Computing Surveys, Vol. 51(3) 2018; or (5) any approach described by Jain, Murty and Flynn: “Data Clustering: A Review”, ACM Computing Surveys, Vol. 31(3) 1999. A partitioning is computed using any relation between collections of points, such as: a shortest-path distance, a geographical distance, a Hausdorff distance, a Jaccard index, a multi-dimensional notion of near, and so on.

The tree P represents a min-structure of travel durations. A min-structure can be characterized as: each node e of a tree represents a lower bound on travel durations associated with points associated with the node e. Several techniques to determine a lower bound are described in the invention disclosure. A min-structure is determined using any manner that could be used by a person of ordinary skill in the art. In one embodiment, we determine the min-structure as follows. For each junction J, we determine a travel duration d_{J→W+S}, that is a sum of the following two travel durations: from J to the work W, and from J to the school S. Each node e has a tag, denoted by P(e), that is a shortest travel duration d_{J→W+S} of any junction J included in the set of junctions associated with the node. Such a tree P can be built in many ways, for example first filling in the tags of the leaves of the tree P, and then proceeding up level-by-level, and setting a tag of a node to a minimum of the tags of its children in the tree P.

We also build a similar tree P_{H}, but for the home H. The tree P_{H} is a partitioning of the junctions. But unlike the tree P that uses d_{J→W+S}, the tree P_{H} uses a travel duration d_{H→J} from the home H to each junction J. The tree P_{H} also represents a min-structure of travel durations. For example, each node e of the tree P_{H} has a tag P_{H}(e), that is a shortest travel duration d_{H→J} of any junction J included in the set of junctions associated with the node.

Any corresponding two nodes of the two trees P and P_{H} have the same associated subsets of junctions. For example, the TopLeft child of the root of P has the same associated area as the TopLeft child of the root of P_{H}.

In one embodiment, we find a junction using a branch-and-bound search among the two trees P and P_{H}. Our goal is to find a junction J, that minimizes a sum d_{H→J}+d_{J→W+S}. The branch-and-bound search traverses the trees P_{H} and P in tandem. During the traversal, we maintain a junction Jₘᵢₙ and a travel duration Dₘᵢₙ. At the start of the traversal, we initialize Dₘᵢₙ to an upper bound on the minimum travel duration (the minimum is smaller or equal than the upper bound). For example, we set Dₘᵢₙ to infinity. The traversal uses a search queue. We initialize the search queue with the root of the tree P. At each step, the traversal removes a node p from the search queue, until the search queue becomes empty. There are two cases. The first case is when the node p has an associated set that consists of a small number of junctions, or the node p is a leaf of the tree P. Then we consider each junction J that is included in the set associated with the node p, and when the travel duration d_{J}=d_{H→J}+d_{J→W+S} via the junction J is shorter than Dₘᵢₙ, then we update Dₘᵢₙ and Jₘᵢₙ, by setting Dₘᵢₙ to that travel duration d_{J}, and by setting Jₘᵢₙ to J. In the other case, we consider the children of the node p in the tree P. Without loss of generality, let us assume that the node p has 4 children, and let us denote their tags by: TL_{P}, TR_{P}, BL_{P} and BR_{P}. Correspondingly, we consider the children of the corresponding node in the tree P_{H}, and examine their tags, that we denote by: TL_{P}_{_{H}}, TR_{P}_{_{H}}, BL_{P}_{_{H}} and BR_{P}_{_{H}}. We then determine which child of the node p to skip traversing. For example, consider the TopLeft child. The sum TL_{P}_{_{H}}+TL_{P} is a lower bound on a travel duration via any junction included in the TopLeft square. If the sum is larger than Dₘᵢₙ, then we skip traversing the TopLeft child of the node p. We skip traversing any other child in a corresponding manner. Any child of the node p that is not skipped, gets enqueued for traversing. Once the traversal has finished, the junction found by the search, is considered to be the Jₘᵢₙ. In one embodiment, the Jₘᵢₙ minimizes a travel duration of the “junction-continue” commute path, and the Dₘᵢₙ is that minimum travel duration.

In the above presentation, we used the term “tree”, and presented explicit steps of building a tree. This simplified the presentation. However, this building is not limiting; in one embodiment, we do not explicitly build a tree.

In one embodiment, we adapt and use any enumeration search, any tree search, any gradient descent search, or any branch-and-bound search, known in the art, or use their combination.

Some examples of adapting an enumeration search follow. In one embodiment, we use said earlier invention disclosures, where a junction corresponds to a site, and a work corresponds to a place. One such use can determine a travel duration between a concrete work and each of a plurality of junctions. And a precomputed such use, can be reused, when searching through the plurality of junctions. In one embodiment, we exclude or limit concrete junctions that are selected, for example based on a convex hull as above.

Some examples of adapting a tree search follow. In one embodiment, we build a tree using any relevant prior art method, or we exclude or limit how we build a tree, for example based on a convex hull as above, or we build a tree that is an approximate shortest-path tree. In one embodiment, we do not explicitly build a tree. In one embodiment, we adapt the approach of hub labels. We determine travel durations based on a direction of travel: for each forward tree, from the root of the tree to each forward hub vertex, and for each reverse tree, from each reverse hub vertex to the root of the tree. And we also determine travel durations: from at least one forward hub vertex to at least one junction vertex, and from at least one junction vertex to at least one reverse hub vertex. And we use these travel durations, to find a junction vertex that minimizes a sum of constituent travel durations via the hubs. In one embodiment, we precompute a minimum travel duration for at least one tuple of hubs, as above. In one embodiment, we extend other approaches for the best via point problem in a similar manner. In one embodiment, we precompute a travel duration, for at least one graph vertex in at least one tree, and store it in a storage medium before the request is received, and then retrieve a travel duration from the storage medium and use it during a tree search.

Some examples of adapting a gradient descent search follow. In one embodiment, we search based on a lower bound on a travel duration via J′. For example, we skip computing a travel duration via a junction near J, when a lower bound on a travel duration via the junction, is at least a travel duration via J. Several techniques to determine a lower bound are described in the invention disclosure. In one embodiment, we use a lower bound on a travel duration via J, rather than a travel duration via J. In one embodiment, we exclude or limit the starting junction J, for example based on a convex hull as above. In one embodiment, we exclude or limit the junctions J′, for example based on a convex hull as above. In one embodiment, we find a junction J′ that yields a shortest travel duration near a J, using any approach described in the invention disclosure, subject to a constraint that the J′ is near the J. In one embodiment, we use a partitioning of junctions, and search among the partitions, for example selecting a partition with a shortest travel duration among the neighbors of a partition, or selecting such a partition that has a smallest lower bound on a travel duration.

Some examples of adapting a branch-and-bound search follow. In one embodiment, we compute a lower bound on the remaining travel duration R, and use it to determine whether to skip computing the remaining travel duration R. In one embodiment, we initialize Jₘᵢₙ to an arbitrary junction, and set Dₘᵢₙ to a travel duration d_{H→J}_{ₘᵢₙ}+d_{J}_{ₘᵢₙ}_{→W+S} via the junction Jₘᵢₙ. In one embodiment, we skip a child when its lower bound is sufficiently high, such as when its lower bound is more than Dₘᵢₙ minus a threshold, such as 1 minute of travel. In one embodiment, we stop the traversal after having performed at least a predetermined number of updates, such as 1 update, or a small number of updates. In one embodiment, we stop the traversal after having visited at least a predetermined number of nodes. In one embodiment, we initialize the search queue with nodes at a certain level in the tree P. In one embodiment, we order the nodes in the search queue based on lower bounds associated with the nodes, for example based on a sum P(e)+P_{H}(e), for example forcing the traversal to remove a node e from the search queue, such that the node has a smallest value of the sum. In one embodiment, in the first case of the branch-and-bound search, we compute a junction J that minimizes the travel duration d_{J}, using any approach described in the invention disclosure, subject to a constraint that the J is included in the junctions associated with the node p. For example, we use any approach for the best via point problem, subject to such a constraint on the via point. In one embodiment, a tree P is reused during branch-and-bound searches for different homes H. In one embodiment, any two trees are merged into one tree, for example by adding the lower bounds associated with each corresponding node. For example, we merge P and P_{H}. And the branch-and-bound search traverses the merged tree. In one embodiment, we merge trees, when the merged tree can be reused. In one embodiment, we exclude or limit an initial junction Jₘᵢₙ, or a junction J, or a child of a node p, for example based on a convex hull as above.

In one embodiment, we determine a junction, by combining any methods for determining a junction recited in the invention disclosure.

In one embodiment, we do not explicitly find a junction, in order to determine a travel duration of the commute path.

Many other ways of determining a travel duration of a “junction-continue” commute path will be apparent to one of ordinary skill in the art, without departing from the scope and spirit of the embodiments.

### 2.2.9 Commute Path: Reversed “Junction-Continue”

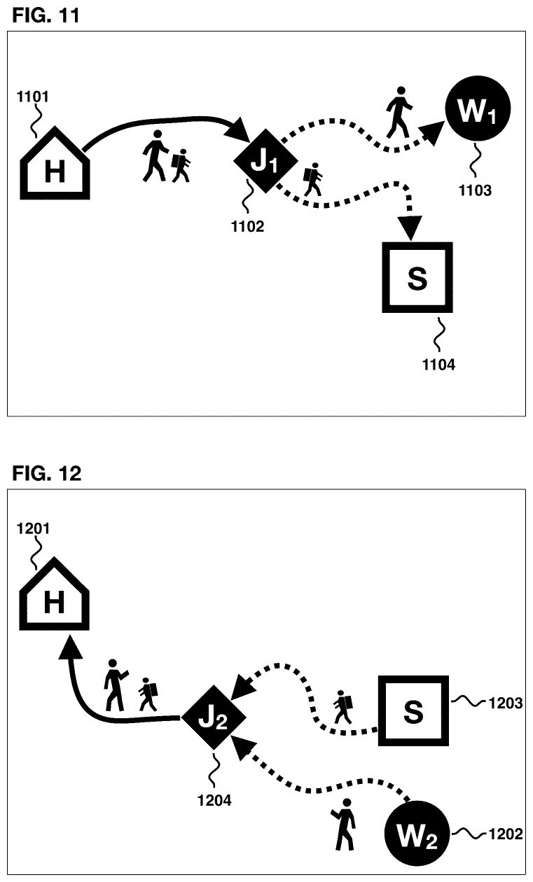

In one embodiment, a commute path is a reversed “junction-continue” commute path (an example is in FIG. 12), where a child travels from a school to a junction, an adult travels from a work to the junction, and then both the adult and the child travel jointly from the junction to a home. A travel duration of the commute path is determined in any manner, that corresponds to a manner of determining a travel duration of a “junction-continue” commute path.

### 2.2.10 Commute Path: “Junction-Back”

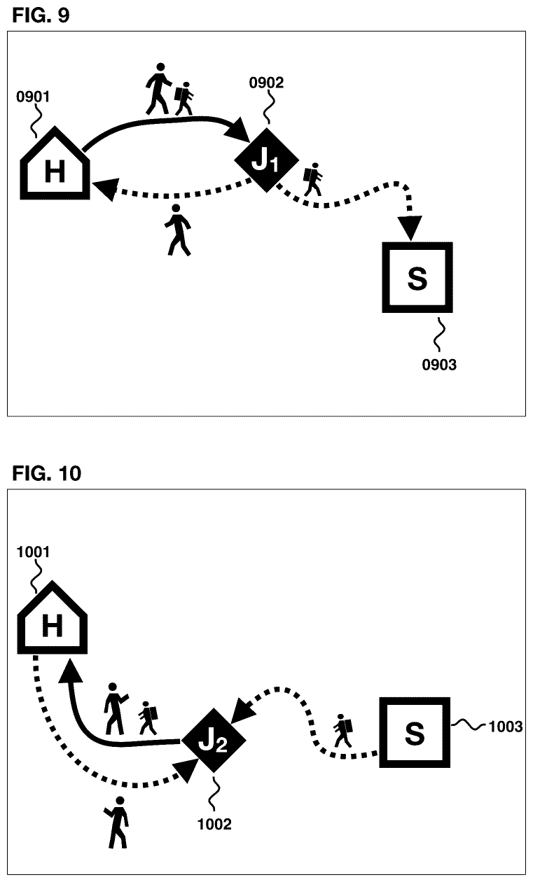

In one embodiment, a commute path is a “junction-back” commute path (an example is in FIG. 9), where:
(a dual description of travel) both an adult and a child travel jointly from a home to a junction, and then
(a singular description of travel) the child continues traveling from the junction to a school, and the adult continues traveling from the junction to the home.

A travel duration of the commute path is determined using any manner that could be used by a person of ordinary skill in the art. In one embodiment, a travel duration of the commute path is a sum of the following three constituent travel durations: from a home to a junction, from the junction to a school, and from the junction to the home. In one embodiment, we determine a travel duration of the commute path, by finding a concrete junction that minimizes the sum, for a concrete home and a concrete school. In one embodiment, a designation dictates that a travel duration between a junction and a school is excluded from a travel duration of the commute path.

In one embodiment, we find a junction using an enumeration search. We examine at least one concrete junction, and determine the following three constituent travel durations: from a home to the junction, from the junction to a school, and from the junction to the home. We sum up these three travel durations. And we find a concrete junction that minimizes the sum, for a concrete home and a concrete school. In one embodiment, an enumeration search does not calculate an optimal route from each of a plurality of “fork” junctions (for example, when the junctions are the first locations on a commute path) to each of at least two points (for example, when the points are the last locations on a commute path), or does not calculate an optimal route from each of at least two points (for example, when the points are the first locations on a commute path) to each of a plurality of “join” junctions (for example, when the junctions are the last locations on a commute path).

In one embodiment, we find a junction using a tree search. For example, (a) we build 3 shortest-path trees in a graph that models a transportation system, based on a direction of travel: a tree forward from a home, a tree reverse from a school, and a tree reverse from the home, at least one graph vertex has a travel duration in each tree, and (b) we find a graph vertex that minimizes a sum of the 3 constituent travel durations in the 3 shortest-path trees.

In one embodiment, we find a junction using a gradient descent search. We start at an arbitrary junction J. Each step of the gradient descent search determines a next junction, based on a lower bound (such as a minimum) on a travel duration of the commute path via a junction near the junction J.

In one embodiment, we find a junction using a branch-and-bound search. Its search tree is a partitioning of the junctions. Its estimate for a branch of the tree anchored at a node, is based on a lower bound (such as a minimum) on travel durations of the commute path, whose junction is included in a part of the partitioning associated with the branch.

In one embodiment, we use any enumeration search, any tree search, any gradient descent search, any branch-and-bound search, or their combination, according to the teachings of the invention disclosure, mutatis mutandis.

Many other ways of determining a travel duration of a “junction-back” commute path will be apparent to one of ordinary skill in the art, without departing from the scope and spirit of the embodiments.

### 2.2.11 Commute Path: Reversed “Junction-Back”

In one embodiment, a commute path is a reversed “junction-back” commute path (an example is in FIG. 10), where a child travels from a school to a junction, an adult travels from a home to the junction, and then both the adult and the child travel jointly from the junction to the home. A travel duration of the commute path is determined in any manner, that corresponds to a manner of determining a travel duration of a “junction-back” commute path.

### 2.2.12 Commute Paths: “Work-Junction”, and Reversed

In one embodiment, a commute path is a “work-junction” commute path, where:
(a dual description of travel) both an adult and a child travel jointly from a home to a work, and then
(a singular description of travel) the child continues traveling without the adult from the work to a junction, and then from the junction to a school.

A travel duration of the commute path is determined using any manner that could be used by a person of ordinary skill in the art. In one embodiment, a travel duration of the commute path is a sum of the following three constituent travel durations: from a home to a work, from the work to a junction, and from the junction to a school. In one embodiment, we determine a travel duration of the commute path, by finding a concrete junction that minimizes the sum, for a concrete home, a concrete work and a concrete school. In one embodiment, a designation dictates that a travel duration between a junction and a school is excluded from a travel duration of the commute path.

In one embodiment, we use any enumeration search, any tree search, any gradient descent search, any branch-and-bound search, or their combination, according to the teachings of the invention disclosure, mutatis mutandis. For example, we use said earlier invention disclosures, where a junction or a school corresponds to a site, and a work corresponds to a place.

In one embodiment, a commute path is a reversed “work-junction” commute path, where a child travels from a school to a junction, and then from the junction to a work, and then an adult and the child travel jointly from the work to a home. Its travel duration is determined in any corresponding manner.

### 2.3 Other Commute Paths

We use other types of a commute path. In one embodiment, a commute path is any commute path described by prior art, and a travel duration of the commute path is determined according to the teachings of the invention disclosure, mutatis mutandis.

In one embodiment, a commute path is a concatenation of a first commute path for travel from a home, with a second commute path in the reverse direction, for travel to the home, where certain entities are matched and where certain points are matched. Examples, based on kernel commute paths, include:
“work-only and reversed”:
   an adult travels from a home to a work,
   and next (reversed)
   form the work to the home;
“school-only and reversed”:
   a child travels from a home to a school,
   and next (reversed)
   from the school to the home;
“school-back and reversed”:
   both an adult and a child travel jointly from a home to a school, and then the adult continues traveling without the child from the school to the home,
   and next (reversed)
   the adult travels from the home to the school, and then both the adult and the child travel jointly from the school to the home;
“school-first and reversed”:
   both an adult and a child travel jointly from a home to a school, and then the adult continues traveling without the child to a work,
   and next (reversed)
   the adult travels from the work to the school, and then both the adult and the child travel jointly from the school to the home;
“work-first and reversed”:
   both an adult and a child travel jointly from a home to a work, and then the child continues traveling without the adult to a school,
   and next (reversed)
   the child travels from the school to the work, and then both the adult and the child travel jointly from the work to the home;
“junction-continue and reversed”:
   both an adult and a child travel jointly from a home to a junction J₁, and then the child continues traveling from the junction J₁ to a school, and the adult continues traveling from the junction J₁ to a work,
   and next (reversed)
   the child travels from the school to a junction J₂, and the adult travels from the work to the junction J₂, and then both the adult and the child continue traveling jointly from the junction J₂ to the home;
“junction-back and reversed”:
   both an adult and a child travel jointly from a home to a junction J₁, and then the child continues traveling from the junction J₁ to a school, and the adult continues traveling from the junction J₁ to the home,
   and next (reversed)
   the adult travels from the home to a junction J₂, and the child travels from the school to the junction J₂, and then both the adult and the child travel jointly from the junction J₂ to the home; and
“work-junction and reversed”:
   both an adult and a child travel jointly from a home to a work, and then the child continues traveling without the adult from the work to a junction J₁, and then from the junction J₁ to a school,
   and next (reversed)
   the child travels from the school to a junction J₂, and from the junction J₂ to the work, and then both the adult and the child travel jointly from the work to the home.

A travel duration of a concatenated commute path is determined using any manner that could be used by a person of ordinary skill in the art. In one embodiment, we determine a travel duration of a concatenated commute path, by adding a travel duration of the first commute path and a travel duration of the second commute path, under the constraints imposed by the matching of entities and points. For example, given a “junction-continue and reversed” commute path, and for a concrete home, a concrete school and a concrete work, we determine a travel duration of the “junction-continue” component, and we determine a travel duration of the “reversed” component, and add them. In one embodiment, this means that we can optimize for a junction J₁, independently from optimizing for a junction J₂, which can simplify optimization.

In one embodiment, a commute path includes at least one additional point. For example, after traveling from a home to a school, a child travels to an additional piano class, and then travels to the home. In other example, an adult drives from a home to an additional parking lot, and then walks to a work. In other example, an adult travels from a school to an additional point A, and then to an additional point B, and then travels to the school. In other example, after a child has boarded a school bus, an adult travels to an additional supermarket, and then travels to a home. Each such additional point: is specified in a restriction on travel along a commute path, or is provided, or is free. In one embodiment, we enumerate at least one concrete point, for a free additional point, when determining a travel duration of the commute path. A travel duration of the commute path is determined using any manner that could be used by a person of ordinary skill in the art. In one embodiment, additional points create additional constituent travel durations. In one embodiment, we add up the additional constituent travel durations, when determining a travel duration of the commute path.

### 2.4 Variants

In one embodiment, a requirement is used to avoid computing a travel duration for some points, for example when the points do not satisfy the requirement (such as a home has too small area). Similarly, in one embodiment, a requirement is used to avoid computing a travel duration between some points, for example when the points do not satisfy the requirement (such as between a home and a school, when the school has too low a rank compared to a price of the home). In one embodiment, we avoid computing a travel duration, when the travel is not feasible.

In one embodiment, we precompute at least one tree, and store it in a storage medium before the request is received, and then retrieve at least one tree from the storage medium and use it during request processing. In one embodiment, a tree is reused when computing a travel duration, for each of a plurality of points. In one embodiment, we precompute, store, retrieve, use or reuse, a part of a tree.

In one embodiment, we use a representation of a tree. In one embodiment, a tree is a hierarchical partitioning of points in a geographical area, where the hierarchy is induced by the inclusion relation. In one embodiment, a tree has a small number of levels, and each internal node fans-out to a small number of children. For example, when a tree has 9 levels, consisting of the following number of nodes: 1×1=4⁰, 2×2=4¹, 4×4=4², . . . , 128×128=4⁷, 256×256=4⁸, then the total number of nodes in the tree is (1−4⁹)/(1−4)=87,381. When the geographical area is a square of size 100 km by 100 km, and each area gets evenly subdivided into 4 squares, then a 9-level tree results in the leaf level corresponding to squares of size 390 m by 390 m. In practical scenarios, such a size is often appropriate to achieve good enough isolation of points at the leaf level of a tree. In one embodiment, we store a tree in a contiguous area of a storage medium, with the root associated with an index 0, and given a node whose index is x, we determine an index of a last child of the node as 4(x+1). We determine an index for any other tree fan-out, in a corresponding manner. In one embodiment, we store a tree in a reverse order. In one embodiment, we represent a travel duration, using any computer encoding of a number that is known in the art. For example, we represent a travel duration at a granularity of seconds, and store it as uint16_t in 2 bytes of a storage medium. Then, one such 9-level tree takes 170 KB of a storage medium. In one embodiment, we represent a travel duration at a granularity of minutes, and store it as float in 4 bytes of a storage medium. Many other examples of representing a tree will be apparent to one of ordinary skill in the art, without departing from the scope and spirit of the embodiments.

In one embodiment, points get filtered based on the request. For example, the request requires top-rank schools only. In such a case, in one embodiment, a search is appropriately modified to focus on filtered points. For example, during searching a tree that is a hierarchical partitioning of the points, we skip descending to a child node, when the child node has no filtered point. For example, we skip descending to a child node, when none of its associated school is a top-rank school. In one embodiment, we use a partitioning of the points after the filtering, such as a hierarchical partitioning of such points. For example, we build a tree that includes only top-rank schools.

Some of the gradient descent searches or the branch-and-bound searches used by our methods, may yield a length of travel of a commute path that is not minimized, for example when the search stops prematurely, such as when the search gets stuck in a local minimum.

### 2.5 Response

The method then responds to the request with a result of searching or comparing, obtained using at least one travel duration of the at least one commute path included in the request. The result is produced according to the optimization goal. In one embodiment, the method produces the result, by computing and using at least one description of travel, rather than at least one travel duration. In one embodiment, the result includes: any information that the method obtained about any point, any information that the method obtained about any transportation system, or any representation or any indication of such information, that is consistent with their interpretation by a person of ordinary skill in the art. For example, the result may include information that no point has been found.

In one embodiment, a method selects some concrete points that are closest to achieving the optimization goal. This is useful, for example, when we wish to determine alternatives, such as alternative schools nearest a given home. Such closest points are selected, using any manner that could be used by a person of ordinary skill in the art. For example, by maintaining a top-k data structure, while examining selections during a search. In one embodiment, a method considers ranges of values of the optimization function, and selects some concrete points for each range, according to the optimization goal. This is useful, for example, when we wish to find a home with a short commute, and also find a home with a long commute. Such range points are selected, using any manner that could be used by a person of ordinary skill in the art. For example, by filtering selections that fall into a range during a search.

In one embodiment, a request is stored in a storage medium, and later a method uses the request to produce at least one result, and responds with the at least one result. This is useful, for example, when we wish to monitor the real estate market over a long period of time, and when a home that suits a prior request appears on the market, then quickly report the home to a user associated with the request. In one embodiment, a result is produced in response to a further request. For example, a prior request is received, which includes at least one commute path and a requirement. Then, the prior request is stored in a storage medium. And at a later time, a further request is received. Then, a method responds to the further request with a result of searching or comparing, obtained using the prior request that gets retrieved from the storage medium.

Any additional manner that describes how a result is produced, is additionally described by the requirement.

In one embodiment, a method of the invention disclosure performs variants of the functionality or steps described in the invention disclosure. In one embodiment, some functionality or steps are performed in other order, partially concurrently, or some functionality or steps are combined or omitted. Many other ways to perform variants of the functionality or steps, will be apparent to one of ordinary skill in the art, without departing from the scope and spirit of the embodiments. In one embodiment, a method uses any such variant.

### 2.6 General Searching or Comparing

In one embodiment, the method receives a request that includes a characterization of an optimization problem, including the following:
a sequence P₁, . . . , Pₘ, [symbol] ₁, . . . , [symbol] ₙ, where each Pᵢ is a provided concrete point, and each [symbol] ᵢ specifies a free point, and where m≥0 and n≥0,
a constraint C, denoting how a concrete point Fᵢ can be selected for each [symbol] ᵢ,
an optimization function V, which assigns a value to any sequence of concrete points P₁, . . . , Pₘ, F₁, . . . , Fₙ, and
an optimization goal G, denoting which values of V, and which concrete points, are sought.

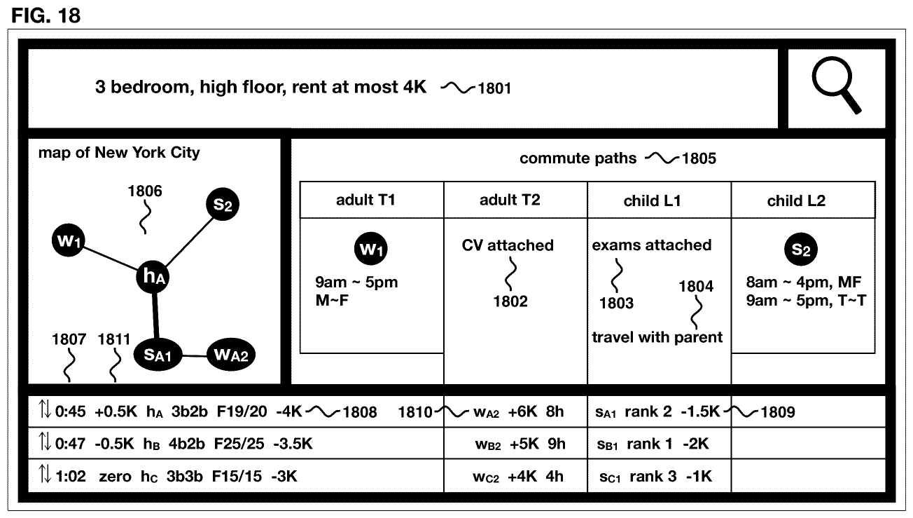

In one embodiment, m≥1 or n≥1. In one embodiment, for any i, a number of concrete points that can be selected for a free point [symbol] ᵢ, is at least a predetermined threshold, or is at most a predetermined threshold, such as a threshold of 2 or a threshold of 1000. In one embodiment, the C represents at least one commute path or a requirement. In one embodiment, the V represents a length of travel of at least one commute path. In one embodiment, any of the C, the V, or the G is independent of the others. In one embodiment, any of the C, the V, or the G dependents on the others. In one embodiment, the characterization includes any embodiment described in the invention disclosure. The characterization may exclude any preset embodiment, for example as in a prior request, or to ensure patentability with respect to prior art. Next, the method examines at least one selection of concrete points, subject to the constraint C. In one embodiment, the selections are examined using an enumeration search, a tree search, a gradient descent search, or a branch-and-bound search. And, the method determines a value of V, for at least one sequence of concrete points. In effect, the method identifies zero or more such selections, according to the goal G. Finally, the method responds to the request with a representation of: the zero or more such selections, or the associated values of V. In one embodiment, the steps include any embodiment described in the invention disclosure. The steps may exclude any preset embodiment, for example as based on a prior request, or to ensure patentability with respect to prior art. An example request and an example response are depicted in FIG. 18.

Solving the optimization problem efficiently is a fundamentally daunting task, for example, because the optimization problem includes in its scope the NP-hard traveling salesman problem (TSP) and the NP-hard vehicle routing problem (VRP). Our methods aim at solving the optimization problem for some practical instances.

### 2.6.1 Inclusion of Kernels

In one embodiment, a commute path includes at least one kernel commute path, where certain entities are matched and where certain points are matched. For example, the commute path illustrated in FIG. 13 includes a commute path illustrated in FIG. 11, and also includes a commute path illustrated in FIG. 12, where:
the adult of FIG. 11 is the same as the adult of FIG. 12,
the child of FIG. 11 is the same as the child of FIG. 12,
the work W₁ of FIG. 11 is the same as the work W₂ of FIG. 12,
the school of FIG. 11 is the same as the school of FIG. 12, and
the home of FIG. 11 is the same as the home of FIG. 12,
however, the junction J₁ of FIG. 11 may be not the same as the junction J₂ of FIG. 12.

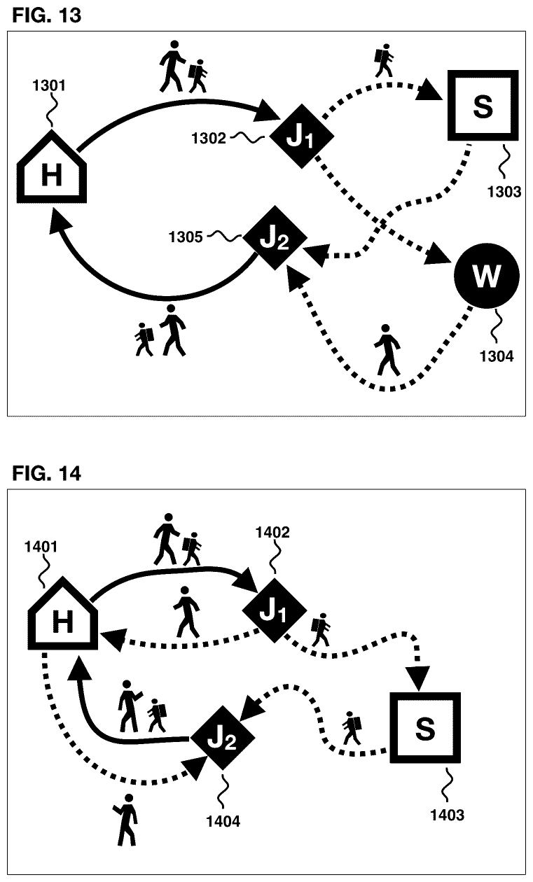

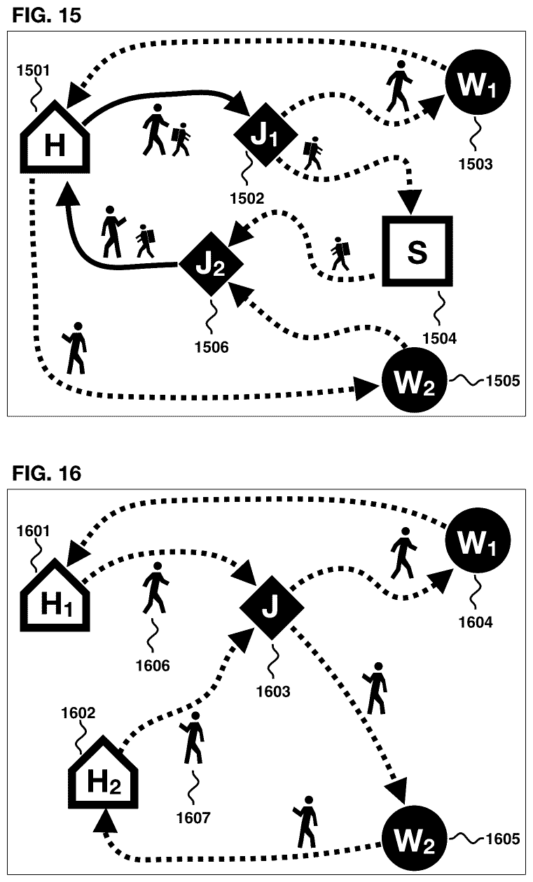

Other examples include: (1) a commute path illustrated in FIG. 14, which includes a commute path illustrated in FIG. 9, and also includes a commute path illustrated in FIG. 10, having one child, and either one adult or two adults; (2) a commute path illustrated in FIG. 15, which includes commute paths illustrated in FIG. 7, FIG. 8, FIG. 11 and FIG. 12, having two adults, one child, one school, one home, and two works; and (3) a commute path illustrated in FIG. 16, which includes two commute paths illustrated in FIG. 7, each of which includes an additional point J, and also includes two commute paths illustrated in FIG. 8, having two adults, two homes, two works, and one junction; the junction J of FIG. 16 may be interpreted as a restaurant where the two adults meet for breakfast before work.

Some kernel commute paths may be precluded from being included in a commute path, for example as in a prior request, or to ensure patentability with respect to prior art.

### 2.6.2 Optimization Plan

A naive solution to the optimization problem selects and evaluates each combination of free points. However, any free point may be selected in many ways, rendering this naive solution too costly for large problem instances. In one embodiment, when the number of combinations is sufficiently small, then we solve the optimization problem, by exhaustively evaluating all combinations. In one embodiment, before the request is received, we precompute at least one rule, each rule matches an instance of the optimization problem with a solution for the instance. The solution is precomputed using any manner that could be used by a person of ordinary skill in the art. When a request is received, that includes a specific instance of the optimization problem, then we find a match among the at least one rule, and use its solution. However, this rule-based solution fails on problem instances that do not match any of the at least one rule.

In general, in one embodiment, we produce an optimization plan that may simplify the optimization problem. We observe that, the optimization function sometimes has an additive structure, in the sense that V(x)=V₁(x₁)+V₂(x₂)+ . . . +Vₖ(xₖ), for k≥2, where the x can be simply obtained from the x₁, . . . , xₖ, where each Vᵢ(xᵢ) can be optimized independently, or concurrently, and where each Vᵢ(xᵢ) may be simpler to optimize than the V(x). We use the phrase optimization subproblem, when referring to the problem of optimizing Vᵢ(xᵢ). In one embodiment, we permit a degenerate case of k=1.

The possible simplification, arises from the following observations. When a free point D, is disconnected from any other free point D′, in the sense that the at least one commute path lacks any direct travel between D and D′ (a direct travel does not pass any point), then such a D gives rise to such a Vᵢ(xᵢ). Unfortunately, a desired disconnection may not exist in a given at least one commute path. However, sometimes, we can force a desired disconnection, by making some free points not free.

Let us illustrate this process via a commute path illustrated in FIG. 13. Let us assume that W is provided, and H, S, J₁ and J₂ are free. We observe that, after we have selected a concrete H and a concrete S, then the contributions of a free J₁ to a travel duration of the commute path are typically independent from the contributions of a free J₂. (Sometimes, a J₁ is actually not independent from a J₂, for example if there is a relationship of an arrival time and a departure time.) Because of the independence, an optimization plan can be executed by: enumerating at least one concrete H and at least one concrete S, and for at least one concrete pair, finding an optimal concrete J₁, and independently finding an optimal concrete J₂, subject to the constraint C. And thus we achieve a requisite additive structure. In contrast, if we select a concrete H and select a concrete J₂, but keep J₁ and S free, then there is a direct travel from J₁ to S, and so a change in a selection of a concrete J₁, may affect which concrete S is optimal. And thus we lack a requisite additive structure.

A problem of finding an additive structure, is related to a combinatorial optimization problem called maximum independent set. In one embodiment, we consider a graph G representing the at least one commute path (an illustration is in FIG. 13), and we find a minimum set N of free vertices, so that after having made them not free, no two remaining free vertices are connected by a direct travel edge (a free vertex and a provided vertex are permitted to be connected by a direct travel edge). Each such remaining free vertex, gives rise to an optimization subproblem. In one embodiment, we do not require the set N to be of a minimum size. The remaining free vertices form an independent set, in a graph that is obtained from the graph G by removing the provided vertices. In one embodiment, we find the set N of free vertices, using any algorithm that computes an independent set, such as: any algorithm that computes a maximum independent set, or any algorithm that computes a maximal independent set, or any such approximation algorithm, or any heuristic. For example, we use any combinatorial optimization algorithm reported in Garey and Johnson: “Computers and Intractability: A Guide to the Theory of NP-Completeness”, W. H. Freeman & Co. 1990.

More generally, a number f≥1 of the remaining free vertices may form a component connected by direct travel edges, but not connected by any direct travel edge to any other remaining free vertex. In one embodiment, the component is minimal with respect to inclusion. This means that, a corresponding Vᵢ requires jointly optimizing f free points (such as J₁ and S of FIG. 13). In other words, the degree of dependence is reflected by the value of f. In one embodiment, we find an additive structure with f≥1, using any manner that could be used by a person of ordinary skill in the art, for example using any prior art combinatorial optimization algorithm, or using a heuristic.

It is illustrative to define a travel-dependent relation, for any given at least one commute path. If the at least one commute path includes a direct travel between a free point X and a free point Y, then we say that X and Y are travel-dependent. If X and Y are travel-dependent, and Y and Z are travel-dependent, then we say that X and Z are travel-dependent. Note that by definition, the travel-dependent relation is symmetric and transitive. We further require that a travel-dependent relation be a minimal such relation. In one embodiment, the problem of finding an additive structure with f≥1, can be viewed as a problem of: changing the free status in the at least one commute path, and achieving certain transitive components of the travel-dependent relation. For example, with a goal of few changes, that achieve small components.

More generally, we identify an additive structure that is approximate. In one embodiment, this means that, we determine an x, such that a value V(x) and an optimum value of V are at most a distortion away from each other, using steps that include: finding x₁, . . . , xₖ that optimize a value of V₁(x₁)+V₂(x₂)+ . . . +Vₖ(xₖ), and simply obtaining the from the x₁, . . . , xₖ. We illustrate a process of identifying an additive structure that is approximate, by observing that, while examining concrete points during an execution of an optimization plan, we can sometimes skip some concrete points, while controlling a change of an optimal value. Let us further illustrate the process via a commute path illustrated in FIG. 13. Let us assume that H, J₁ and J₂ are free. Let us further assume that the H can be selected in two ways only, as a concrete H₁ or as a concrete H₂. And let us assume that any shortest travel duration between the H₁ and the H₂ is at most d. Then, given a selection of concrete points in the commute path, that selects the H₂ for the H, it follows that, replacing the H₂ with the H₁ in the selection, does not change a travel duration of the commute path by more than 2 d. Therefore, there is a limited harm caused by not selecting the H₂ for the H. In one embodiment, we identify an additive structure that is approximate, using steps that include: (1) determining two concrete points H₁ and H₂ among the points that can be selected for a free point H in the at least one commute path, such that a travel duration between the H₁ and the H₂ is at most a threshold, such as 200 meters or 1 minute of travel; and (2) during an execution of an optimization plan, we skip examining a selection that selects the H₂ for the H; in effect, other concrete point replaces the H₂. In one embodiment, we identify an additive structure that is approximate, using clustering. We examine any free point H in the at least one commute path. And we determine at least one cluster of the points that can be selected for the free point H, using any clustering method based on a travel duration. And during an execution of an optimization plan, we skip examining at least one selection, that selects a member of a cluster for the H, but we examine a selection, that selects a concrete representative r of the cluster for the H. Such a replacement introduces a distortion of the approximation, that is at most, the number of direct travel edges incident with the H, in the graph representing the at least one commute path, multiplied by a distortion dr introduced by the representative r. In the case when the representative r is a centroid, then the distortion dᵣ is the cluster radius. In one embodiment, we tighten the distortion of the approximation, by separately counting a distortion introduced by each direct travel edge incident with the H. In one embodiment, we consider such a replacement, when the distortion of the approximation is at most a threshold, such as 200 meters or 1 minute of travel. In one embodiment, we identify an additive structure that is approximate, using any manner that could be used by a person of ordinary skill in the art, for example using a heuristic. An additive structure that is approximate, can be viewed as an approach of sparsification.

The total cost of executing an optimization plan depends on: the cost of finding an additive structure, and the cost of optimizing the additive structure. In one embodiment, we minimize a cost. In one embodiment, we do not minimize a cost. Besides, sometimes there is a constraint on our choice of which free point to make not free. For example, we may wish to make homes not free, because we want to find a home for each range of a travel duration, or we may wish to make schools not free, because we want to find alternative schools nearest a given home, or we may wish to limit the distortion introduced by the approximation to at most a threshold. In one embodiment, we use a constraint. In one embodiment, we do not use a constraint. In one embodiment, we arbitrarily determine which free point to make not free, if any. In one embodiment, an optimization subproblem is the same as the optimization problem (that is, k=1). In general, we produce an optimization plan, using any approach that could be used by a person of ordinary skill in the art, based on some of the teachings of the invention disclosure, such as the teachings included in paragraphs [102] to [110], for example using any prior art Operations Research algorithm, or using a heuristic. The optimization plan may exclude any preset embodiment, for example as based on a prior request, or to ensure patentability with respect to prior art.

### 2.6.3 Optimization of a Subproblem

We now turn our attention to an optimization subproblem of optimizing Vᵢ. Some optimization approaches for the case f=1 have already been described, including approaches of: an enumeration search, a tree search, a gradient descent search, and a branch-and-bound search. Next, we describe optimization approaches for the general case of f≥1.

After possibly renaming, and without loss of generality, let us describe the optimization subproblem as follows:
(1) the [symbol] ₁, . . . , [symbol] _{f} are free points, f≥1;
(2) some of the [symbol] _{f+1}, . . . , [symbol] ₙ have been made not free; and
(3) no free point among the [symbol] _{f+1}, . . . , [symbol] ₙ, is connected by a direct travel in the at least one commute path with a free point among the [symbol] ᵢ, . . . , [symbol] _{f}.
   The above description of the optimization subproblem is determined in any manner that could be used by a person of ordinary skill in the art, based on how an optimization plan was produced. For example, by traversing a graph representing the at least one commute path, and identifying a component of the travel-dependent relation. In one embodiment: f=1, f≥2, f=n, f<n, or f<n−1. In one embodiment, there is no direct travel between any two of the [symbol] ᵢ, . . . , [symbol] _{f}.

For any 1≤j≤f, let Dⱼ be the set of points connected by a direct travel with [symbol] ⱼ. The set Dⱼ consists of three types of points:
(1) some of the [symbol] ᵢ, . . . , [symbol] _{f};
(2) some of the [symbol] _{f+1}, . . . , [symbol] ₙ that are provided, we denote them by a set Rⱼ; and
(3) some of the [symbol] _{f+1}, . . . , [symbol] ₙ that had been free, but were made not free, we denote them by a set Nⱼ.
   The set Dⱼ does not include any other point. In one embodiment: Rⱼ is empty, Nⱼ is empty, Rⱼ is not empty, Nⱼ is not empty, Rⱼ has only one point, Nⱼ has only one point, Rⱼ has at least two points, or Nⱼ has at least two points.

The free points [symbol] ᵢ, . . . , [symbol] _{f} are the subject of optimizing Vᵢ. For this purpose, we present several types of searches next. Because of the manner in which an optimization plan is executed, we can further assume that, a concrete point has already been selected, for each point in each Nⱼ (the points in each Rⱼ are already concretely provided).

In one embodiment, we use an enumeration search. Subject to the constraint C, we examine at least one tuple, where each tuple (F₁, . . . , F_{f}) consists of a sequence of concrete points, and where each concrete Fⱼ is selected for the corresponding [symbol] ⱼ. For at least one such tuple, we determine constituent travel durations in the at least one commute path:
(1) between the concrete Fₓ selected for [symbol] ₓ, and the concrete F_{y} selected for [symbol] _{y}, for any 1≤x≤f, and any 1≤y≤f, when there is a direct travel between the [symbol] ₓ and the [symbol] _{y}; and
(2) between the concrete Fⱼ, and at least one concrete point in Rⱼ∪Nⱼ, for any 1≤j≤f.
   Using these constituent travel durations, we determine a value of Vᵢ for the tuple. And we find a tuple that meets the optimization goal G. We repeat the enumeration search, if necessary. And we determine zero or more tuples (F₁, . . . , F_{f}) that meet the optimization goal G.

In one embodiment, we use a tree search. We consider a graph that models a transportation system. Each vertex of the graph, represents a selection of a concrete Fⱼ. Subject to the constraint C, for at least one j, such that 1≤j≤f, and at least one concrete point E in Rⱼ∪Nⱼ, we use the graph to build a shortest-path tree rooted at E, based on a direction of travel between E and the [symbol] ⱼ in the at least one commute path. Subject to the constraint C, we examine at least one tuple, where each tuple (F₁, . . . , F_{f}) consists of a sequence of concrete points, and where each concrete Fⱼ is selected for the corresponding [symbol] ⱼ. For at least one such tuple, we determine constituent travel durations in the at least one commute path:
(1) between the concrete Fₓ selected for [symbol] ₓ, and the concrete F_{y} selected for [symbol] _{y}, for any 1≤x≤f, and any 1≤y≤f, when there is a direct travel between the [symbol] ₓ and the [symbol] _{y}; and
(2) between the concrete Fⱼ, and at least one concrete point in Rⱼ∪Nⱼ, for any 1≤j≤f, by retrieving a relevant travel duration from a shortest-path tree.
   Using these constituent travel durations, we determine a value of Vᵢ for the tuple. And we find a tuple that meets the optimization goal G. We repeat the tree search, if necessary. And we determine zero or more tuples (F₁, . . . , F_{f}) that meet the optimization goal G.

In one embodiment, we use a gradient descent search. We start at an arbitrary tuple (F₁, . . . , F_{f}) of concrete points, subject to the constraint C. Then, the search repeatedly performs the following steps, until a stop. Subject to the constraint C, we determine a tuple (F′₁, . . . , F′_{f}) of concrete points that is near the tuple (F₁, . . . , F_{f}), and where the tuple (F′₁, . . . , F′_{f}) best meets the optimization goal G. If the tuple (F′₁, . . . , F′_{f}) improves the optimization goal G, then we set (F₁, . . . , F_{f}) to (F′₁, . . . , F′_{f}), and continue the search. Else, we stop the search. And we find a tuple that meets the optimization goal G. We repeat the gradient descent search, if necessary. And we determine zero or more tuples (F₁, . . . , F_{f}) that meet the optimization goal G.

In one embodiment, we use a branch-and-bound search. For each 1≤j≤f, we build a tree Tⱼ that represents a partitioning of points [symbol] ⱼ. We use any embodiment for computing a partitioning recited in the invention disclosure. A tree may use a different partitioning, compared to that used by other tree. In one embodiment, a tree is built, subject to the constraint C. The trees are traversed in unison. The search queue stores tuples of nodes of the trees. We initialize the search queue to a tuple of roots of the trees. We also initialize Vₘᵢₙ to an upper bound on a value of Vᵢ, such as infinity. At each step, we remove a tuple from the search queue, until the search queue becomes empty. Let us denote the removed tuple by (p₁, . . . , p_{f}). There are two cases. The first case is when: each node pⱼ is a leaf of its tree Tⱼ, or when the nodes consist of a small number of concrete points, subject to the constraint C. In this case, subject to the constraint C, we determine constituent travel durations in the at least one commute path between the following endpoints:
(1) between at least one concrete F′ₓ selected for [symbol] ₓ, and at least one concrete F′_{y} selected for [symbol] _{y}, for any 1≤x≤f and any 1≤y≤f, when there is a direct travel between the [symbol] ₓ and the [symbol] _{y}, and f′ₓ is included in the node pₓ, and F′_{y} is included in the node p_{y}; and
(2) between at least one concrete F′ⱼ and at least one concrete point in Rⱼ∪Nⱼ, for any 1≤j≤f, when F′ⱼ is included in the node pⱼ.
   Using these constituent travel durations, we determine a value of Vᵢ, for at least one such tuple (F′₁, . . . , F′_{f}). When the value Vᵢ is less than Vₘᵢₙ, then we update Vₘᵢₙ and (F₁, . . . , F_{f}), by setting Vₘᵢₙ to the value Vᵢ, and setting (F₁, . . . , F_{f}) to (F′₁, . . . , F′_{f}). In the other case, we consider the children of each node pⱼ in its tree Tⱼ. Subject to the constraint C, for at least one tuple (n₁, . . . , n_{f}) of the respective children, we decide if the tuple (n₁, . . . , n_{f}) should be skipped. For this purpose, we determine a lower bound L on the value of Vᵢ for the tuple (n₁, . . . , n_{f}). The lower bound L concerns a part of the travel duration of the at least one commute path, the part concerning travel between the following endpoints:
(1) between at least one concrete F′ₓ selected for [symbol] ₓ, and at least one concrete F′_{y} selected for [symbol] _{y}, for any 1≤x≤f and any 1≤y≤f, when there is a direct travel between the [symbol] ₓ and the [symbol] _{y}, and F′ₓ is included in the node nₓ, and F′_{y} is included in the node n_{y}; and
(2) between at least one concrete F′ⱼ and at least one concrete point in Rⱼ∪Nⱼ, for any 1≤j≤f, when F′ⱼ is included in the node nⱼ.
   Several techniques to determine the lower bound L are described in the invention disclosure (for example, see Section 2.6.4). When the lower bound L is greater or equal to Fₘᵢₙ, then the tuple (n₁, . . . , n_{f}) is skipped. Any tuple that is not skipped, gets enqueued for traversing. And we find a tuple that meets the optimization goal G. We repeat the branch-and-bound search, if necessary. And we determine zero or more tuples (F₁, . . . , F_{f}) that meet the optimization goal G.

In one embodiment, we solve the optimization subproblem, using any manner that could be used by a person of ordinary skill in the art. For example, we use any enumeration search, any tree search, any gradient descent search, any branch-and-bound search, or we adapt any search, as above, or we use their combination, according to the teachings of the invention disclosure, mutatis mutandis.

### 2.6.4 Lower Bound L

We now turn our attention to determining a lower bound L for the at least one commute path. This lower bound concerns a part of the at least one commute path, representing travel incident with any of the [symbol] ₁, . . . , [symbol] _{f}, where each endpoint [symbol] ⱼ can be selected only from the concrete points included in the node nj. Some embodiments of determining a lower bound have already been described in the invention disclosure.

In general, we use any of several techniques to determine a lower bound L. In order to simplify the explanation how a lower bound is determined, we consider a simple commute path from A to B to C, where A can be selected from {a₁, a₂}, B can be selected from {b₁, b₂}, and C can be selected from {c₁, c₂}. However, this simplification is not limiting. Any of the techniques is used to determine a lower bound in the general case, in any manner that could be used by a person of ordinary skill in the art. One technique enumerates at least one instance, and computes a minimum travel duration of the instances, or computes a smallest lower bound on a travel duration of the instances. However, the number of instances may be exponential. For example, there are 8=2·2·2 instances of the simple commute path. So this technique may be costly. Other technique, approximates the part by a chain, following the direction of travel in the part. For example, we create a source vertex, and connect the source vertex to each aᵢ using an edge of zero weight. We also create a target vertex, and connect each cᵢ to the target vertex using an edge of zero weight. Then, we connect each aᵢ to each bⱼ, and we connect each bᵢ to each cⱼ, using an edge with a weight of a travel duration between the two. Then, we compute a shortest path from the source vertex to the target vertex. And we set the lower bound to a length of the shortest path. Other technique, approximates the part by at least one chain. Other technique, approximates the part by at least one minimum spanning tree (MST), and uses a weight of each minimum spanning tree to set the lower bound. Other technique, sets the lower bound based on straight line geographical distances, for example, as a distance from A to B, plus a distance from B and C, each divided by a speed, such as an average speed. Other technique, relaxes the shape of the part, so that the travel from A to B can be disconnected from the travel from B to C. For example, an instance may be: a₁→b₁ and b₂→c₁. Such a relaxation enables a use of an additive property: the lower bound is a sum of partial lower bounds: (1) a lower bound on a travel duration from A to B, plus (2) a lower bound on a travel duration from B to C. Each partial lower bound has fewer instances, and so may sometimes be evaluated less costly. However, relaxing the shape may cause the lower bound to be not tight. Other technique approximates travel durations of the part. For example, we determine: (1) a location aᵣ that represents {a₁, a₂}, (2) a location bᵣ that represents {b₁, b₂}, and (3) a location cᵣ that represents {c₁, c₂}, such that these locations distort travel durations in a controlled manner. Such locations can be computed using any clustering method, for example as centroids. And then we approximate each instance of the simple commute path by aᵣ→bᵣ→cᵣ. Thus, the lower bound is a sum of: (1) a lower bound on a travel duration from aᵣ to bᵣ, plus (2) a lower bound on a travel duration from bᵣ to cᵣ, minus (3) a distortion of a travel duration introduced by the locations aᵣ, bᵣ and cᵣ. Other technique, considers each pair of endpoints of travel included in the part, determines a representative near each endpoint, and computes a travel duration between the two representatives, and then sets a lower bound using the travel durations. Other technique, considers each pair of endpoints of travel included in the part, determines a meeting hub for travel between the endpoints, and computes a travel duration between the meeting hub and each endpoint, and then sets a lower bound using the travel durations. Other technique, considers each pair of endpoints of travel included in the part, examines a contraction hierarchy, determines a shortcut for the pair, and computes a travel duration of the shortcut, and then sets a lower bound using the travel durations. Other technique, uses any relevant prior art, in any manner that could be used by a person of ordinary skill in the art. In one embodiment, we combine the techniques, or use one technique for a fragment of the part, and use other technique for other fragment. Many other examples of using the techniques to determine a lower bound L will be apparent to one of ordinary skill in the art, without departing from the scope and spirit of the embodiments.

Let us further illustrate the general techniques via an elaborate example. It is convenient to decompose a lower bound L into a sum L=Lᵢₙₜₑᵣₙₐₗ+Lₑₓₜₑᵣₙₐₗ, where the Lᵢₙₜₑᵣₙₐₗ is restricted to direct travel between any of the free points (that is, any of [symbol] ₁, . . . , [symbol] _{f}), and the Lₑₓₜₑᵣₙₐₗ is restricted to direct travel between any of the free points, and any of the not free point (that is, any of ∪ⱼ₌₁^{f}(Rⱼ∪Nⱼ)).

We first focus on a lower bound Lₑₓₜₑᵣₙₐₗ. Recall that a tree Tⱼ represents a partitioning of the points [symbol] ⱼ. In one embodiment, we use the same partitioning, to construct trees that represent travel between the [symbol] ⱼ, and concrete points specified by the at least one commute path. For this purpose, consider a concrete point X in Rⱼ∪Nⱼ. If the at least one commute path has a direct travel from the X to the [symbol] ⱼ, then we build a tree using the partitioning. The tree represents lower bounds on travel durations from the X, to various sets of concrete points associated with nodes of the tree Tⱼ. Specifically, the tree represents a min-structure: each node e of the tree has a tag, that is a lower bound on a travel duration, from the X to any concrete point Fⱼ included in the node of the tree Tⱼ that corresponds to the node e. We denote the tree by P_{X→} [symbol] _{ⱼ}, and the tag of a node e of the tree is denoted by P_{X→} [symbol] _{ⱼ}(e). If the at least one commute path has a direct travel in the opposite direction, from [symbol] ⱼ to X, then we build a “reverse” tree P [symbol] _{ⱼ}_{→X}, using the same partitioning, and tag the tree correspondingly. We build such trees for at least one j, such that 1≤j≤f. We build any such tree, using any relevant embodiment described in the invention disclosure. In one embodiment, a tree is built, subject to the constraint C. Now recall a tuple (n₁, . . . , n_{f}). The tuple represents restrictions on how a concrete point can be selected for each of [symbol] ₁, . . . , [symbol] _{f}. We can establish a lower bound Lₑₓₜₑᵣₙₐₗ for the tuple, by simply summing up the relevant tags, across all relevant direct travels in the at least one commute path, as follows:

$${L}_{external} ( {n}_{1} , … , {n}_{f} ) = {\sum }_{j = 1}^{f} {\sum }_{X ∈ ( {R}_{j} ⋃ {N}_{j} )} ( {{\sum }_{direct travel}}_{X \to {ℱ}_{j}} {P}_{X \to {ℱ}_{j}} ( {n}_{j} ) + {{\sum }_{direct travel}}_{{ℱ}_{j} \to X} {P}_{{ℱ}_{j} \to X} ( {n}_{j} ) ) .$$

Next, we focus on a lower bound Lᵢₙₜₑᵣₙₐₗ. In one embodiment, this lower bound is a sum of lower bounds on direct travels in the at least one commute path, between the free points [symbol] ₁, . . . , [symbol] _{f}, as follows:

$${L}_{internal} ( {n}_{1} , … , {n}_{f} ) = {\sum }_{1 \leq x , y \leq f} {{\sum }_{direct travel}}_{{ℱ}_{x} \to {ℱ}_{y}} {L}_{{ℱ}_{x} \to {ℱ}_{y}} ( {n}_{x} , {n}_{y} )$$

Hence, it is enough to focus on one direct travel from [symbol] ₓ to [symbol] _{y}, for a certain a and a certain y, such that 1≤x≤f and 1≤y≤f, and focus on a lower bound L [symbol] _{ₓ}_{→} [symbol] _{_{y}}(nₓ, n_{y}) on travel duration of the direct travel, where the endpoint [symbol] ₓ is restricted to the concrete points included in the node nₓ, and the endpoint [symbol] _{y} is restricted to the concrete points included in the node n_{y}.

In one embodiment, travel between endpoints can be approximated well by shortest travel. An example scenario is when the travel is on foot. In any case, recall that the tree Tₓ represents a partitioning of points [symbol] ₓ. In one embodiment, such a partitioning represents a hierarchical clustering, where the cluster radius decreases, as we move down the hierarchy. Such a partitioning can be computed using any clustering method. The tree T_{y} also represents such a partitioning. Let dₓ denote the cluster radius of the node nₓ, and let d_{y} denote the cluster radius of the node n_{y}. Because of the shortest path property, a shortest travel duration from any selection Fₓ to any selection F_{y}, has to be at least a shortest travel duration from the centroid of the node nₓ to the centroid of the node n_{y}, minus the distortion (dₓ+d_{y}). We determine a lower bound L′ on a shortest travel duration between the pair of centroids, using any technique to determine a lower bound described in the invention disclosure, and then we set a lower bound [symbol] (nₓ, n_{y}) to the value of L′−(dₓ+d_{y}). In one embodiment, we precompute a lower bound between at least one pair of centroids, and store it in a storage medium before the request is received, and then retrieve a precomputed lower bound from the storage medium, and use it during request processing, rather than computing the lower bound after the request is received. More generally, in one embodiment, instead of a centroid of a cluster, we use a representative of the cluster, and instead of a cluster radius, we use a distortion introduced by the representative.

In one embodiment, travel between endpoints cannot be approximated well by shortest travel. An example scenario is when the travel is by a school bus, and the school bus meanders around a residential area, or two schools have disjoint bus networks, that cannot be combined. In any case, in one embodiment, we build a tree [symbol] , that represents a min-structure on pairs of nodes in the trees Tₓ and T_{y}. The min-structure includes lower bounds on travel durations from nodes of Tₓ to nodes of T_{y}. In one embodiment, we determine the min-structure as follows. We start at a leaf [symbol] ₓ of the tree Tₓ and a leaf [symbol] _{y} of the tree T_{y}. Then, we compute a lower bound on travel duration from any concrete point included in [symbol] ₓ to any concrete point included in [symbol] _{y}, using any technique to determine a lower bound described in the invention disclosure. We assign the lower bound to a tag [symbol] ( [symbol] ₓ, [symbol] _{y}). Then we move up the trees, and compute a lower bound and a tag for a pair of nodes, for example, by taking a minimum lower bound, across all pairs consisting of a child from Tₓ and a child from T_{y}. And then we set a lower bound [symbol] (nₓ, n_{y}) to the tag [symbol] (nₓ, n_{y}) of the node (nₓ, n_{y}) of the tree [symbol] . In one embodiment, we compute a lower bound for a limited collection of pairs of nodes, for example only for nodes that are nearby. In one embodiment, a tree [symbol] is built, subject to the constraint C. In one embodiment, we precompute a lower bound for at least one pair of nodes and store it in a storage medium before the request is received, and then retrieve a precomputed lower bound from the storage medium, and use it during request processing, rather than computing the lower bound after the request is received.

### 2.6.5 Sparsification

In one embodiment, we use an approach that replaces some of the concrete points with a concrete representative. Thereby, we can sometimes decrease the number of selections that need to be considered, because a concrete representative is considered, rather than each of several concrete points. We described one such approach in Section 2.6.2 above. We describe other such approach next.

Consider any solution to the optimization subproblem, ignoring for the time being how the solution was computed. Let us make a few observations about the solution, with respect to representatives. Consider any concrete point P in ∪ⱼ₌₁^{f}(Rⱼ∪Nⱼ). And consider any direct travel P-Fᵢ in the at least one commute path, between the P and a concrete Fᵢ selected for a free point [symbol] ᵢ in the solution, 1≤i≤f. There are two cases. Case A: the direct travel P-Fᵢ passes a representative R. In this case, the solution can be simply obtained by solving a modified subproblem, where we: (A1) remove the direct travel P- [symbol] ᵢ, from the at least one commute path; (A2) add a corresponding direct travel, between the representative R and the [symbol] ᵢ, to the at least one commute path; and (A3) modify the optimization function, so as to compensate for the removed travel between the P and the representative R. Case B: the direct travel P-Fᵢ does not pass any representative. In this case, the solution can be simply obtained by solving a modified subproblem, where we: (B1) remove the direct travel P- [symbol] ᵢ, from the at least one commute path; (B2) make the [symbol] ᵢ not free, by way of selecting the Fᵢ for the [symbol] ᵢ; and (B3) modify the optimization function, so as to compensate for the removed travel between the P and the Fᵢ. We further observe that, because of the manner in which representatives are determined, when the P and the Fᵢ are sufficiently far from each other, then a shortest path between the two endpoints should pass a representative. Thus, we expect that Case A will occur in the solution, when a direct travel between the two endpoints is sufficiently long. Further, by applying the modifications to each direct travel incident with the P, we can remove the P from the subproblem, while adding some concrete representatives or making some free points not free, and also while modifying the optimization function. In one embodiment, we do not compensate in step (A3), or we do not compensate in step (B3). Note that, the modified subproblem maintains an invariant of operating on some free points that are a subsequence of the [symbol] ₁, . . . , [symbol] _{f}, and that the subsequence may be connected by direct travel with some representatives. This invariant enables recursion.

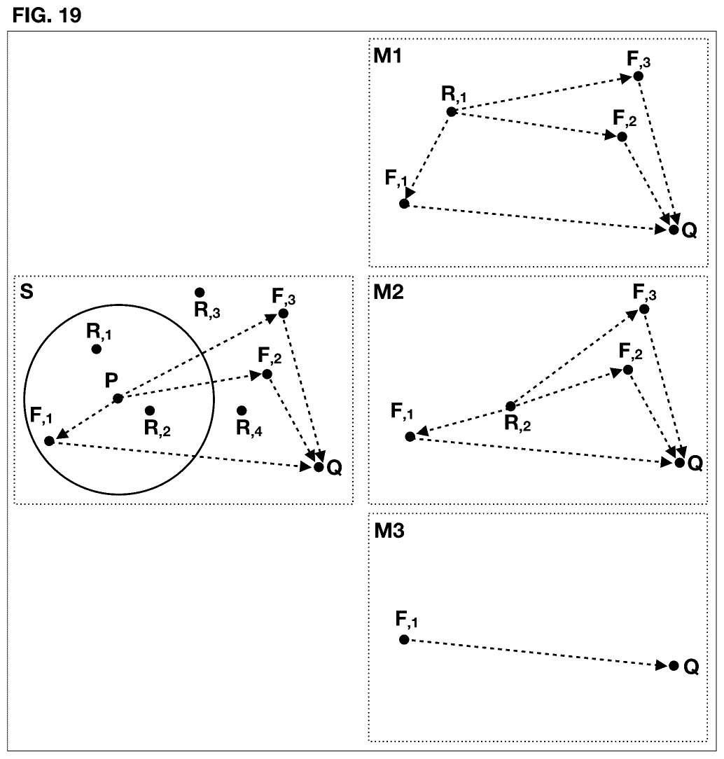

The above observations motivate the following approach of sparsification, illustrated in FIG. 19. Consider a sequence S of the free points in the current subproblem. The sequence S consists of some of the [symbol] ₁, . . . , [symbol] _{f}. We pick an arbitrary concrete point P in the current subproblem. Then, for each direct travel P- [symbol] ᵢ, between the P and an [symbol] ᵢ in the sequence S, we identify: (1) representatives R_{i,1}, . . . , R_{i,r}_{ᵢ} near the P, the representatives depend on the travel and its direction, here rᵢ≥0; and (2) concrete points F_{i,1}, . . . , F_{i,f}_{ᵢ}, that can be selected for the [symbol] ᵢ near the P, here fᵢ≥0. In each case, we use any notion of near described in the invention disclosure. In one embodiment, we use a big enough neighborhood, to ensure that rᵢ≥1, fᵢ≥1, or rᵢ+fᵢ≥1. In one embodiment, we determine that Case A does not occur, and then step (1) is skipped, setting rᵢ to zero. In one embodiment, we determine that Case B does not occur, and then step (2) is skipped, setting fᵢ to zero. The rᵢ and the fᵢ are determined in the context of a specific direct travel P- [symbol] ᵢ, and when we wish to emphasize the context, then we use notations rᵢ[P- [symbol] ᵢ] and fᵢ[P- [symbol] ᵢ]. Then, we generate at least one modified subproblem. Each modified subproblem combines modifications resulting from each direct travel, as follows: (1) for each direct travel P- [symbol] ᵢ, between the P and any [symbol] ᵢ that is in the sequence S, we either: add one of the rᵢ[P- [symbol] ᵢ] concrete representatives, and connect it with the [symbol] ᵢ using a corresponding direct travel; or we select one of the fᵢ[P- [symbol] ᵢ] concrete points, thus making [symbol] ᵢ not free; in each case, we compensate the optimization function according to the above observations; and (2) we remove the P, and we modify the optimization function, based on any removed direct travel between the P and a concrete point external to the sequence S. In one embodiment, we do not modify the optimization function in step (2). The number of the thus generated modified subproblems is

$${\prod }_{{F}_{i} ∈ sequence S} {{\prod }_{dir ect travel}}_{P - {ℱ}_{i}} ( {r}_{i} [ P - {ℱ}_{i} ] + {f}_{i} [ P - {ℱ}_{i} ] ) .$$

And then we recursively solve each modified subproblem. We cut off the recursion at any stage. A base recursive subproblem is solved using any manner that could be used by a person of ordinary skill in the art. For example, using any approach described in the invention disclosure mutatis mutandis, such as retrieving a precomputed solution. And we pick a solution that best meets the optimization goal. In one embodiment, we use said earlier invention disclosures, where the P corresponds to a place, and the points that can be selected for the [symbol] ᵢ correspond to some sites. For example, we precompute a description of travel between each representative and each of the points that can be selected for the [symbol] ᵢ. This can be helpful, when the request filters some of the points that can be selected for the [symbol] ᵢ, because one precomputing can be reused, when producing a result for any kind of filtering. At first glance, the multiplications involving (rᵢ+fᵢ) lead to an exponential explosion of subproblems. However, the value of (rᵢ+fᵢ) is often low in practice, and many useful commute paths will result in a shallow depth of the recursion. Thus, the exponential explosion can typically be controlled in practice. Besides, the recursion is naturally parallelizable.

In general, the approach of sparsification uses the above observations in any manner that could be used by a person of ordinary skill in the art. We provide a few example uses next.

In one embodiment, a commute path includes a direct travel between a free point [symbol] and a free point [symbol] ′. For example, the at least one commute path specifies travel from a home to a work. In the embodiment, we can apply the above observations, wherein the [symbol] acts as the [symbol] ᵢ, and wherein a concrete point F′ selected for the [symbol] acts as the P. This results in determining r′ concrete representatives near the F′, and also determining f′ concrete points near the F′, that can be selected for [symbol] . Different selections of F′ may result in different sets of representatives. However, these sets may overlap. Symmetrically, we can apply the above observations, wherein the [symbol] acts as the [symbol] ᵢ, and wherein a concrete point F selected for the [symbol] acts as the P. As a result, we may generate modified subproblems, each subproblem corresponds to a direct travel between a concrete point selected for the [symbol] and a nearby concrete point selected for the [symbol] ′; and we may generate modified subproblems, each subproblem corresponds to a direct travel between: a concrete representative near a concrete point that can be selected for the [symbol] , and a concrete representative near a concrete point that can be selected for the [symbol] . Because of the overlaps, a number of distinct subproblems will be at most: a number of pairs of nearby [symbol] and [symbol] , plus a square of a number of representatives. In general, in a corresponding manner, we can apply the above observations to the case when, a commute path includes some number k≥2 of free points, and there is at least one direct travel between a pair of the free points.

In one embodiment, a commute path includes a direct travel from a concrete point S, to a free point [symbol] , and then to concrete point T. For example, the at least one commute path specifies the best via point problem. In the embodiment, we can apply the above observations, wherein the S acts as the P and the [symbol] acts as the [symbol] ᵢ. This results in determining r_{S} concrete representatives near the S, and also determining f_{S} concrete points near the S, that can be selected for [symbol] . Symmetrically, we can apply the above observations, wherein the T acts as the P and the [symbol] acts as the [symbol] ᵢ. This results in determining r_{T} concrete representatives near the T, and also determining f_{T} concrete points near the T, that can be selected for [symbol] . As a result, we generate the following three types of modified subproblems: (1) f_{S} subproblems, each subproblem corresponds to a direct travel to the T from a concrete point near the S selected for the [symbol] ; (2) f_{T} subproblems, each subproblem corresponds to a direct travel from the S to a concrete point near the T selected for the [symbol] ; and (3) r_{S}·r_{T} subproblems, each subproblem corresponds to travel from a concrete representative near the S, to a free point [symbol] , and then to a concrete representative near the T. The total number of generated modified subproblems is f_{S}+f_{T}+r_{S}·r_{T}. In one embodiment, we precompute at least one solution to the subproblem of type (3), and store it in a storage medium before the request is received, and then retrieve a precomputed solution from the storage medium, and use it during request processing. Because of the overlaps, a number of distinct subproblems will be at most: a number of pairs of nearby S and [symbol] , plus a number of pairs of nearby T and [symbol] , plus a square of a number of representatives. In general, in a corresponding manner, we can apply the above observations to the case when, a commute path includes a free point and some number k≥1 of concrete points, and there is a direct travel between each of the concrete points and the free point.

In one embodiment, in a corresponding manner, we can apply the above observations to the case when, a commute path includes some free points connected by some direct travels among themselves, and where each free point may be connected by some direct travels with some concrete points. This case is equivalent to the above description of the optimization subproblem.

In one embodiment, a commute path includes a direct travel between a concrete point P₁ and a concrete point P₂. For example, the at least one commute path specifies travel from a provided starting location to a provided target location, without any free point. In the embodiment, we can apply the above observations, wherein the P₁ acts as the P, and wherein the P₂ acts as the Fᵢ. This results in determining ri concrete representatives near the P₁, and possibly also determining that the P₂ is near the P₁. Symmetrically, we can apply the above observations, wherein the P₂ acts as the P, and wherein the P₁ acts as the Fᵢ. This results in determining r₂ concrete representatives near the P₂, and possibly also determining that the P₁ is near the P₂. As a result, we may generate one modified subproblem that corresponds to a direct travel between the P₁ that is near the P₂, and we may generate r₁·r₂ modified subproblems, each subproblem corresponds to a direct travel between a concrete representative near the P₁ and a concrete representative near the P₂.

In total, we generate at most 1+r₁·r₂ modified subproblems. Because of the overlaps, a number of distinct subproblems will be at most: a number of pairs of nearby P₁ and P₂, plus a square of a number of representatives.

There is a connection between the above approach of sparsification and a certain routing method prevalent in the industry. In a basic case, when the at least one commute path specifies only travel from a provided starting location to a provided target location, then the approach of sparsification can be considered to be similar to a routing method based on certain two-side representatives. The routing method is described, for example, in clam 1 of prior art U.S. Pat. No. 8,417,409, and the method is mentioned in a plethora of prior art patent documents. Thus, our approach of sparsification could be viewed as a generalization of the prevalent routing method. The generalization enables more complex travel, than just travel from a provided starting location to a provided target location, and also enables some endpoints to be free, rather than only provided. Intriguing, isn't it?

Any approach of sparsification may exclude any preset embodiment, for example as based on a prior request, or to ensure patentability with respect to prior art.

In one embodiment, we solve the optimization subproblem using steps that include: (1) determining at least one representative, that replaces at least one free point, according to any approach of sparsification described in the invention disclosure, and (2) performing a search through the at least one representative, rather than through the concrete points that can be selected for the at least one free point; the search uses an optimization function, according to the approach of sparsification. For example, we perform a branch-and-bound search, on the above r_{S}·r_{T} pairs of representatives. In one embodiment, we replace every free point. In one embodiment, we do not replace every free point. In one embodiment, we combine two sparsification approaches, for example we replace some concrete points with a representative of a cluster, but replace other concrete points with representatives.

In one embodiment, we combine any approach of sparsification, with any approach of the invention disclosure, using any manner that could be used by a person of ordinary skill in the art.

### 2.6.6 Variants

In one embodiment, a method solves an instance of the optimization problem that is recited in the invention disclosure, using any enumeration search, any tree search, any gradient descent search, any branch-and-bound search, or any their combination, according to the teachings of the invention disclosure, mutatis mutandis. In one embodiment, a method solves an instance of the optimization problem, using any approach that could be used by a person of ordinary skill in the art, based on the teachings of the invention disclosure, for example using any heuristic, or any prior art Operations Research algorithm, such as: any combinatorial optimization algorithm or any approach reported in Bodin and Golden: “Classification in vehicle routing and scheduling”, Networks, Vol. 11(2) 1981. In one embodiment, we use any first approach of the invention disclosure, as part of any second approach of the invention disclosure, by appropriately detaching the first approach, and renaming an interface between the two approaches. For example, in the approach of sparsification, we solve a modified subproblem using a branch-and-bound search, or in any method that uses representatives, we use the smoothing of said earlier invention disclosures. In one embodiment, a method may exclude any preset manner of solving any preset instance of the optimization problem, for example as in a prior request, or to ensure patentability with respect to prior art. Many other ways of solving the optimization problem will be apparent to one of ordinary skill in the art, without departing from the scope and spirit of the embodiments.

### 3 Computer System and Apparatus

Embodiments of the invention include a computer system. The computer system has a hardware embodiment, a software embodiment, or a combination of the two. The computer system includes at least one processor, for example a CPU or a GPU. The computer system includes a storage medium, such as: a non-transitory computer-readable storage medium, a volatile memory, a non-volatile memory, or a database. The storage medium stores one or more programs for execution by the at least one processor. The one or more programs comprise instructions to be executed by the at least one processor, so as to perform at least one step of a method described in the invention disclosure. In one embodiment, the instructions are expressed in any programming language, for example C++, Java or JavaScript. In one embodiment, the one or more programs use the storage medium to store or to retrieve information about at least one point or information about at least one transportation system. In one embodiment, the computer system includes at least one network component, which is used by the one or more programs to receive information from data sources, or to transmit information to data sinks. In one embodiment, the use regards a receipt or regards a transmission, in any specific way. Any such computer system can be viewed as a general-purpose computer that is specifically programmed to realize a specific method described in the invention disclosure. Therefore, in effect, the computer system is a special purpose computer, programmed to perform specific steps of the method, in accordance with the instructions of the software (the one or more programs) that encode the method. In one embodiment, at least one part, or every part, of the computer system has a physical or a tangible embodiment. In one embodiment, at least one part, or every part, of the computer system has a non-physical or a non-tangible embodiment. Many other embodiments of a computer system will be apparent to one of ordinary skill in the art, without departing from the scope and spirit of the embodiments. Each method of the invention disclosure, includes an embodiment of any computer system, that realizes the method.

Embodiments of the invention include an apparatus. The apparatus can be embodied: as a physical device; as an interactive computer service; as a smartphone application; as a webpage; as a washing machine of the New Zealand Article 11, that is controlled by software as such, where the software implements a method described in the invention disclosure; as a boxer glove, that punches a result of searching or comparing on the rear of a patent examiner, who lied in order to coerce the applicant into unnecessarily restricting the scope of patent claims; and so on. An example presentation of an apparatus is depicted in FIG. 18. It will be obvious to anyone of ordinary skill in the art, that the presentation of an apparatus can be modified (for example, by rearranging, resizing, changing colors, shape, adding or removing components), without departing from the scope and spirit of the embodiments. The apparatus receives a request from a user via a “receiver”, for example: a User Interface of the smartphone application, for example where the user can: provide the address of a work by typing into a search box, tap a map displayed by the smartphone application in order to provide a location of a work, talk to a speech recognition engine to describe a location of a work, input a GPS reading that encodes a location of a work, and so on. In one embodiment, the receiver receives any information included in a request described in the invention disclosure. The apparatus then produces a result, using any method described in the invention disclosure. In one embodiment, the result is produced by a computer system, that realizes the method. The apparatus then transmits the result to the user via a “transmitter”, for example: a display in the smartphone application, a speech synthesizer (for example, by talking to the user), an augmented reality lens included in glasses mounted on the head of the user, a 3D projector of the Jedi Knights, a boxer glove, and so on. It will be obvious to anyone of ordinary skill in the art, that the invention is not limited to one kind of apparatus, neither to one kind of receiver, nor to one kind of transmitter. In one embodiment, at least one part, or every part, of the apparatus has a physical or a tangible embodiment. In one embodiment, at least one part, or every part, of the apparatus has a non-physical or a non-tangible embodiment. Many other embodiments of an apparatus will be apparent to one of ordinary skill in the art, without departing from the scope and spirit of the embodiments. Each method of the invention disclosure, includes an embodiment of any apparatus, that realizes the method.

### 4 Claim Interpretation

Each claim is interpreted using the following principle:
PRINCIPLE of CLAIM INTERPRETATION: broadest reasonable interpretation by a person skilled in the art, in light of the description and the drawings.

The principle implies that: if an embodiment E of a claim is excluded from patentability, within a specific jurisdiction where this patent application is filed, then the person skilled in the art will not consider the embodiment E to be a reasonable interpretation of the claim, and thus the person skilled in the art will not consider the embodiment E to be included in the interpretation of the claim, within the jurisdiction. Any embodiment that is non-patentable within the jurisdiction, is implicitly excluded from the scope of the claim. The scope of the claim, excludes any embodiment that is ineligible for a patent within the jurisdiction.

For example, consider the jurisdiction of Canada. Thus, the following statement, that is directed towards a patent application filed in Canada, is false: the invention described in a claim of the patent application is directed towards non-patentable subject matter.

For example, consider the jurisdiction of the European Patent Convention. The following embodiments defined by Article 52 EPC, are excluded from patentability within the jurisdiction:
“Article 52
Patentable inventions
   . . .
(2) The following in particular shall not be regarded as inventions within the meaning of paragraph 1:
   (a) discoveries, scientific theories and mathematical methods;
   (b) aesthetic creations;
   (c) schemes, rules and methods for performing mental acts, playing games or doing business, and programs for computers;
   (d) presentations of information.
(3) Paragraph 2 shall exclude the patentability of the subject-matter or activities referred to therein only to the extent to which a European patent application or European patent relates to such subject-matter or activities as such.” (https://www.epo.org/law-practice/legal-texts/html/epc/2020/e/ar52.html)
   Any such embodiment defined by Article 52 EPC, thus is implicitly excluded from the scope of each claim of a patent application filed before the European Patent Office.

Those of ordinary skill in the art shall notice, that various modifications may be made, and substitutions may be made with essentially equivalents, without departing from the scope and spirit of the embodiments. Besides, a specific situation may be adapted to the teachings of the invention, without departing from the scope and spirit of the embodiments. Therefore, despite the fact that the invention has been described with reference to the disclosed embodiments, the invention shall not be restricted to these embodiments. Rather, the invention will include all embodiments that fall within the scope of the claims, in accordance with the above PRINCIPLE of CLAIM INTERPRETATION.

For example, those of ordinary skill in the art know, how to create the “manner of manufacture” within the meaning of the Statute of Monopolies used by Australia Patent Office, for any part of any claim. Hence, any method of any claim, includes any embodiment that realizes the “manner of manufacture”, in accordance with the above PRINCIPLE of CLAIM INTERPRETATION. For example, those of ordinary skill in the art also know, how to create the “technical character” within the meaning of the European Patent Convention, for any part of any claim. Hence, any method of any claim, includes any embodiment that realizes the “technical character”, in accordance with the above PRINCIPLE of CLAIM INTERPRETATION. In general, those of ordinary skill in the art know, how to create embodiments of any claim, that are patentable within a jurisdiction. Hence, any method of any claim within the jurisdiction, includes any such patentable embodiment, in accordance with the above PRINCIPLE of CLAIM INTERPRETATION.

It is regrettable, that so much space of the invention disclosure needs to be used, in order to counter acts of certain patent examiners, who issue objections of non-patentable subject matter, in order to coerce the applicant into unnecessarily restricting the scope of a patent claim. Such patent examiners know, that a patent clam includes many patentable embodiments. Nevertheless, such patent examiners coerce the applicant into excluding some patentable embodiments. Such patent examiners sometimes use a deceitful tactic of merely declaring that an argument (such as above) of the applicant is not persuasive, in effect evading specifically addressing the argument. Such patent examiners sometimes use an even more brazenly deceitful tactic, by simply proclaiming that they addressed the argument, even while it is plainly clear that they ignored the argument. Considering that such patent examiners are adequately intelligent, there is a reason to believe, that they issue the objections mala fide, in order to facilitate theft of intellectual property within certain jurisdictions, or swindle the applicant into paying a fee for an appeal, a hearing or a lawsuit. In particular, it is not appropriate for a patent examiner to invoke a European Magic Convention, and, under a disguise of an objection, hocus-pocus a deletion of some steps of a claim, in a covert attempt to swindle the applicant into an unnecessary restriction of the scope of a claim. In particular, it is not appropriate for a commissioner of patents to lie in order to conceal an earlier lie of his colleague, and swindle the applicant into paying 70,000 USD for an appeal to a high court of Australia.

Not every patent office is rotten to the core. On 2022 Jul. 11, Japan Patent Office issued objections of non-patentable subject matter, concerning a patent application JP 2021-51052. In response, on 2022 Aug. 9, the applicant stated the following: “In summary, claim 1includes an embodiment that: (a) uses hardware, and (b) does not use human activities. No reasonable person will add a nonpatentable embodiment to the scope of claim 1. Therefore, the applicant finds the objections of the Japan Examiner to be untenable.” In response, on 2022 Nov. 22, Japan Patent Office granted a patent JP 7181562. The applicant acknowledges Japan Patent Office for acting honestly.

### 5 Closing Paragraphs

Any prior art cited in the invention disclosure is considered to be ordinary knowledge in the art; any person of ordinary skill in the art has that knowledge.

Antecedent basis is sometimes tracked with boxes in the claims: a [symbol] in a claim can later be used as the

[symbol]

We include a glossary of selected phrases that occur in the claims, and example references to the description. These references are not intended to be exhaustive; other references exist. The sequence of the phrases in the table is intended to follow the appearance order in the claims.

| phrase | example reference |
|---|---|
| searching or comparing | paragraph [013], [019] |
| point | paragraph [014] |
| travel, description of travel | paragraph [015] |
| transportation system | paragraph [016] |
| entity | paragraph [015] |
| request | paragraph [021] |
| commute path | paragraph [021] |
| specification, specifies | paragraph [021] |
| junction | paragraph [046], [047] |
| travel to junction, travel from junction | paragraph [046] |
| result | paragraph [092] |
| optimization problem | paragraph [097] |
| optimization goal | paragraph [013], [097] |
| depends, is independent | paragraph [097] |
| enumeration search | paragraph [050], [072], [115] |
| tree search | paragraph [051], [073], [116] |
| gradient descent search | paragraph [052], [074], [117] |
| branch-and-bound search | paragraph [053], [075], [118] |
| Operations Research | paragraph [110], [139] |
| free point | paragraph [023] |
| select point | paragraph [023] |
| point N, point F | paragraph [113] |
| make not free | paragraph [104] |
| remaining free points, remaining free | paragraph [106 |
| vertices | |
| direct travel | paragraph [104] |
| concrete point | paragraph [023] |
| select / selecting / find a concrete point | Section 2.6 |
| optimization subproblem | paragraph [103] |
| point P | paragraph [129] |
| free point F | paragraph [129] |
| nearby point | paragraph [129] |
| nearby representative | paragraph [129] |
| modified subproblem | paragraph [129] |
| concrete point H₁, concrete point H₂ | paragraph [109] |
| skip examining selection | paragraph [109] |

1. A method for searching or comparing at least two points, using travel within a transportation system by at least two entities, the method comprising:
(a) receiving a request comprising at least one commute path,
i. wherein a commute path included in the at least one commute path, includes a specification of travel within the transportation system by two or more entities included in the at least two entities,
ii. wherein the specification specifies travel between at least one pair of points included in the at least two points,
iii. wherein the at least one pair includes at least one junction, and
iv. wherein each junction included in the at least one junction, specifies a plurality of entities, that travel to the junction or travel from the junction, and each of the plurality of entities is included in the two or more entities;
(b) determining at least one description of travel within the transportation system of the at least one commute path; and
(c) responding to the request with a result of searching or comparing obtained using the at least one description of travel.

2. A method for searching or comparing at least three points, using travel within a transportation system, the method comprising:
(a) receiving a request comprising an optimization problem that includes at least one commute path,
i. wherein each commute path included in the at least one commute path, specifies travel within the transportation system, between at least one pair of points included in the at least three points;
(b) solving the optimization problem, using an approach that includes:
i. an enumeration search,
ii. a tree search,
iii. a gradient descent search,
iv. a branch-and-bound search, or
v. an Operations Research search,
wherein an optimization goal included in the optimization problem depends on at least one description of travel within the transportation system of the at least one commute path; and
(c) responding to the request with a result of searching or comparing obtained using the at least one description of travel.

3. A method for searching or comparing at least three points, using travel within a transportation system, the method comprising:
(a) receiving a request comprising an optimization problem that includes at least one commute path,
i. wherein each commute path included in the at least one commute path, specifies travel within the transportation system, between at least one pair of points included in the at least three points, and
ii. wherein each of one or more free points included in the at least one pair, is free to be selected in at least two ways, among the at least three points;
(b) determining at least one point N among the one or more free points, making each point N not free, and determining at least one point F among the remaining free points, wherein the at least one commute path excludes any direct travel between any point included in the at least one point F and any remaining free point not included in the at least one point F;
(c) solving the optimization problem, using an approach that includes:
i. selecting a concrete point, for each of the at least one point N, and
ii. solving an optimization subproblem included in the optimization problem, by selecting a concrete point, for each of the at least one point F,
wherein an optimization goal included in the optimization problem depends on at least one description of travel within the transportation system of the at least one commute path; and
(d) responding to the request with a result of searching or comparing obtained using the at least one description of travel.

4. A method for searching or comparing at least two points, using travel within a transportation system, the method comprising:
(a) receiving a request comprising an optimization problem that includes at least one commute path, that includes a specification of travel within the transportation system between a point P, and a free point F that is free to be selected in at least two ways, among the at least two points;
(b) determining
i. at least one nearby representative, or
ii. at least one nearby point included in the at least two points, that is near the point P;
(c) generating a modified subproblem based on the optimization problem, by removing the specification of travel, and instead:
i. adding a specification of modified travel between the free point F and a nearby representative included in the at least one nearby representative, or
ii. specifying that a nearby point is selected for the free point F, wherein the nearby point is included in the at least one nearby point;
(d) solving the optimization problem, using an approach that includes solving the modified subproblem,
wherein an optimization goal included in the optimization problem depends on at least one description of travel within the transportation system of the at least one commute path; and
(e) responding to the request with a result of searching or comparing obtained using the at least one description of travel.

5. A method for searching or comparing at least two points, using travel within a transportation system, the method comprising:
(a) receiving a request comprising an optimization problem that includes at least one commute path, that includes a specification of travel within the transportation system, wherein the specification of travel includes at least one free point, each is free to be selected in at least two ways, among the at least two points;
(b) determining a free point H included in the at least one free point, and determining a concrete point H₂ distinct from a concrete point H₁, each can be selected for the free point H, such that a length of travel between the concrete point H₁ and the concrete point H₂ is at most a threshold;
(c) solving the optimization problem, using an approach that skips examining any selection of the concrete point H₂ for the free point H,
wherein an optimization goal included in the optimization problem depends on at least one description of travel within the transportation system of the at least one commute path; and
(d) responding to the request with a result of searching or comparing obtained using the at least one description of travel.
